(19) United States
(12) Patent Application Publication
(10) Pub. No.: US 2007/0155863 A1
(43) Pub. Date: Jul. 5, 2007

(54) Novel "green" materials from soy meal and natural rubber blends

(75) Inventors: Amar K. Mohanty, Lansing, MI (US); Qiangxian Wu, East Lansing, MI (US); Susan Selke, East Lansing, MI (US)

Correspondence Address: Ian C. McLeod;IAN C. McLEOD, P.C., 2190 Commons Parkway, Okemos, MI, 48864, US

(73) Assignee: Board of Trustees of Michigan State University, East Lansing, MI (US)

(21) Appl. No.: 11/639,203

(22) Filed: Dec. 14, 2006

Related U.S. Application Data
(63) Continuation-in-part of application No. 11/200,593, filed on Aug. 10, 2005.
(60) Provisional application No. 60/629,663, filed on Nov. 19, 2004.
(60) Provisional application No. 60/602,727, filed on Aug. 19, 2004.

(51) Int. Cl. C08L 97/02

(52) U.S. Cl. 524/9

(57) ABSTRACT

Blended compositions and methods for the production of thermoset compositions of soy meal, which has been treated to remove non-thermoplastic materials associated with soy beans, and natural rubber. Also provided is a method for the preparation of a prepared granular soy meal by blowing a gas through a stream of granular natural soy meal to remove hulls and cellulose fiber materials which are lighter than the granular soy meal to provide the prepared granular soy meal for the compositions. The compositions are elastic and can be used in place of rubber bands and the like.

### CROSS-REFERENCE TO RELATED APPLICATIONS

This application is a continuation-in-part of U.S. patent application Ser. No. 11/200,593 to Mohanty et al., filed Aug. 10, 2005 which claims priority to U.S. Provisional Application No. 60/629,663 filed Nov. 19, 2004 and U.S. Provisional Application No. 60/602,727 filed Aug. 19, 2004, each of which are incorporated by reference herein in their entirety.

### STATEMENT REGARDING FEDERALLY SPONSORED RESEARCH OR DEVELOPMENT

Not Applicable.

### BACKGROUND OF THE INVENTION

(1) Field of the Invention

The present invention relates generally to the utilization of thermoplastic blended compositions of soy meal and natural rubber for the preparation of thermoset biodegradable elastomers.

(2) Description of the Related Art

Non-biodegradable plastics, which are mainly from petroleum resources, are becoming a burden on local landfill. Non-biodegradable plastics waste also increases the pollution of greenhouse gas emissions when burned, which causes the present global warming problem (Kerr, R. Science. 2000, 288 (5466), 589) and (Patel, M. Ph.D. Thesis, Closing carbon cycles: carbon use for materials in the context of resource efficiency and climate change, Utrecht University, Netherlands, December 1999). Therefore, biodegradable polymers have attracted much attention.

At present, biodegradable polymers include synthetic polymers, such as polylactic acid (PLA), biopolymers produced by microorganism, such as polyhydroxybutyrate (PHB) and natural biopolymers, such as starch and protein. The former two kinds (PLA and PHB) of biodegradable polymers are costly (Okada, M. Prog. Polym. Sci. 2002, 27, 87). Special attention is paid to natural biopolymers because they are abundant and low cost.

Soy protein, as the most abundant protein in the world, is classified into soy protein isolate (SPI), soy concentrate (SC), soy flour (SF), and soy meal (SM) their costs being ˜$1.50; ˜$0.80; ˜0.20; ˜$ 0.08 per pound respectively. The cheapest soy protein is SM (0.18 US$/kg) (Information from Michigan Soybean Promotion Committee, January, 2003), which contains a minimum of 44% protein. However, this protein has poor processability because protein content is low and non-thermoplastic content is high.

Usually, soy protein isolate containing at least 90% protein has been used to prepare biodegradable materials, as mentioned in several patents (U.S. Pat. Nos. 6,632,925 to Zhang et al; 5,710,190 to Jane et al; 5,523,293 to Jane et al and 5,397,834 to Jane et al). In these processes, SPI, plasticizers such as water and glycerol, and other biodegradable polymers such as polylactic acid (PLA), were mixed and fed into an extruder to prepare pellets or foam. Rayas and Hernandez (U.S. Pat. No. 6,045,868) used wheat flour, glycerol as plasticizer, and formaldehyde solution as the cross-linking agent to prepare protein film. Bassi et al (U.S. Pat. No. 5,665,152 to Bassi et al) disclosed a composition of blends of grain protein with starch. The blends were said to be useful for molded plastics, but became brittle and sensitive to water. Sun et al (U.S. Pat. No. 6,716,022 to Sun et al) used wheat straw fiber, soy flour and water to compression-mold livestock feed supplement containers. These containers also became brittle at ambient conditions. As reported, (Zhong et al., Polymer, 2001, 42, 696) soy protein isolate/polycaprolactone blends (50 g/50 g) were brittle (σ=5-7 MPa, ε_{b}=2-3%), and became tough (σ_{b}=25-27 MPa, ε_{b}=10-12%) after cross-linking using 5 wt % of methylene diphenyl diisocyanate. However, the two raw materials are expensive.

However, there still exist the following main drawbacks for protein-rich biodegradable materials that has not been overcome by these patents. (1.) Protein becomes brittle at dry state due to the loss of water; (2.) Protein is difficult to process due to a high melting temperature. Therefore, a large amount of plasticizer is needed for processing; (3.) Protein is sensitive to water and has weak mechanical properties in a wet state; (4). At a high relative humidity state, plasticizers, such as glycerol or sorbitol, can penetrate out of protein matrix, and form liquid-like drops on the surface of a film. This phenomenon is called as “leaching”. The leaching phenomenon limits the usage of natural biopolymers. (5). When the content of protein in polymers blends reaches up to 50 wt % or higher, the mechanical properties of the blends decrease dramatically and can not satisfy customers' requirement. (6). Soy protein isolate which contains around 90% protein is expensive (˜3.3 US$/kg) for plastic applications.

The price of natural rubber (NR, 1.16˜1.43 US$/kg for Standard Malaysian Rubber (SMR) Information from http://www.rubbercommerce.com/priceindices_unreg.jsp#, update Jul. 23, 2004) is cheaper than that of low density polyethylene (LDPE, 1.47˜1.69 US$/kg, Information from http://www.plasticsnews.com/subscriber/resin/pricel.html, update Jul. 23, 2004). In addition, natural rubber is a bio-based and biodegradable natural polymer while LDPE is not. Therefore, natural rubber has potential for developing low cost biodegradable polymers. Ezoe (U.S. Pat. No. 5,523,331 to Ezoe) blended natural rubber (67 wt %) and starch etc., in an extruder, and then vulcanized the blends to prepare biodegradable articles. But it was difficult to reduce the content of natural rubber below 50% because starch was not plasticized, making the blends difficult to process if starch content reached a high level. Japanese Patent, P2001-288295A, to Katuaki directly blended natural rubber (60 wt %) and corn protein to prepare biodegradable thermoplastic in an extruder, but the blends had leaching problems because of the presence of the large amount of plasticizers, such as glycerol. In addition, the blends were very sticky because the natural rubber was not vulcanized. To improve the flexibility of thermoplastic starch, 2.5-20 wt % of natural rubber was blended into a starch matrix in an intensive mixer at 150° C. (Carvalho, A. J. F.; Job, A. E.; Alves, N.; Curvelo, A. A. S.; Gandini, A., Carbohydr. Polym. 2003, 53(1), 95). Results revealed a reduction in tensile strength and an improvement in flexibility. These blends can have stickiness problems, although the natural rubber content is low.

While the related art teach blends of natural rubber and biopolymers, there still exists a need for improved biodegradable thermoset blended compositions.

### OBJECTS

Therefore, it is an object of the present invention to provide thermoset blended compositions from soy meal and natural rubber.

It is further an object of the present invention to provide vulcanized thermoset blended compositions which are low cost, elastic and biodegradable.

These and other objects will become increasingly apparent by reference to the following description.

### SUMMARY OF THE INVENTION

The present invention provides an uncured and unvulcanized thermoplastic blended composition which comprises: (a) a soy meal mixture, the soy meal which has been treated to remove hulls and cellulose fiber materials associated with soy beans, the mixture comprising about 20% or less by weight water; and (b) an unvulcanized natural rubber mixture having sulfur as a vulcanization agent and a vulcanization accelerator, wherein the blended composition can be vulcanized to a thermoset solid.

In further embodiments, the soy meal mixture has been processed at 80-100° C. In still further embodiments, the soy meal mixture to natural rubber mixture ratio is approximately 70:50 (w/w). In still further embodiments, the vulcanization accelerator is a dithiocarbamate accelerator. In still further embodiments, the dithiocarbamate accelerator is zinc diethyldithiocarbamate (ZDEC). In still further embodiments, the composition further comprises a compatibilizer. In further embodiments, the compatibilizer is calcium sulfate dihydrate (CSD).

The present invention provides a thermoset blended composition which comprises: (a) a soy meal mixture, the soy meal which has been treated to remove hulls and cellulose fiber materials associated with soy beans, the mixture comprising about 20% or less by weight water; and (b) a natural rubber mixture having sulfur as a vulcanization agent and a vulcanization accelerator, wherein the blended composition has been vulcanized to a thermoset solid.

In further embodiments, the soy meal mixture to natural rubber mixture ratio is approximately 70:50 (w/w). In still further embodiments, the soy meal is approximately 51 percent by weight of the composition when dried. In still further embodiments, the vulcanization accelerator is a dithiocarbamate accelerator. In still further embodiments, the dithiocarbamate accelerator is zinc diethyldithiocarbamate (ZDEC). In further embodiments, the composition has been vulcanized at approximately 90° C. In still further embodiments, the soy meal mixture has been processed at 80-100° C. In still further embodiments, the composition further comprises a compatibilizer. In further embodiments, the compatibilizer is calcium sulfate dihydrate (CSD).

The present invention provides a method for the production of a thermoset blended composition which comprises: (a) providing a soy meal mixture, which has been treated to remove hulls and cellulose fiber materials associated with soy beans, the soy meal mixture comprising about 20% or less by weight water; and unvulcanized natural rubber containing sulfur as a vulcanization agent, and a vulcanization accelerator; and (b) vulcanizing the blended composition to produce the thermoset solid composition.

In further embodiments of the method, the vulcanization is performed at approximately 90° C. In still further embodiments, the soy meal mixture has been processed at 80-100° C. In still further embodiments, the soy meal mixture to natural rubber mixture ratio is approximately 70:50 (w/w). In still further embodiments, the vulcanization accelerator is a dithiocarbamate accelerator. In still further embodiments, the dithiocarbamate accelerator is ZDEC. In still further embodiments, the soy meal is approximately 51 percent by weight of the composition when dried. In still further embodiments, the soy meal mixture and unvulcanized natural rubber further comprises a compatibilizer. In further embodiments, the compatibilizer is calcium sulfate dihydrate (CSD).

The present invention relates to a thermoset blended composition which comprises soy meal, which has been treated to remove hulls and cellulose fiber materials associated with soy beans, the soy meal containing less than about 7.5% water; and vulcanized natural rubber. Preferably, the composition comprises 30% to 70% soy meal, 12.5% to 62.5% unvulcanized rubber which has been vulcanized, and 7.5% to 17.5% water, all by weight. Preferably, the rubber was vulcanized with sulfur as a vulcanization agent and a vulcanization accelerator. Most preferably, the rubber was vulcanized with sulfur and zinc diethyldithiocarbamate as a vulcanization accelerator. Most preferably the composition is substantially free of organic plasticizers. In still further embodiments, the composition further comprises a compatibilizer. In further embodiments, the compatibilizer is calcium sulfate dihydrate (CSD).

The present invention relates to an uncured and unvulcanized thermoplastic blended composition which comprises a blend of soy meal, which has been treated to remove hulls and cellulose fiber materials associated with soy beans, the soy meal comprising between about 5% and 10% by weight water; and unvulcanized natural rubber containing sulfur as a vulcanization agent and a vulcanization accelerator, wherein the blended composition can be vulcanized to a thermoset solid. Preferably, the composition comprises 30% to 70% soy meal, 12.5% to 62.5% vulcanized natural rubber, and 7.5% to 17.5% water, all by weight. Most preferably, the unvulcanized natural rubber comprises sulfur as a vulcanization agent and zinc diethyldithiocarbamate as an accelerator. Most preferably the composition is substantially free of organic plasticizers. In still further embodiments, the composition further comprises a compatibilizer. In further embodiments, the compatibilizer is calcium sulfate dihydrate (CSD).

The present invention also relates to a method for the production of a thermoset blended composition which comprises providing a blend of soy meal, which has been treated to remove hulls and cellulose fiber materials associated with soy beans, the soy meal comprising between about 5% and 10% by weight water; and unvulcanized natural rubber containing sulfur as a vulcanization agent, and a vulcanization accelerator; and vulcanizing the blended composition to produce the thermoset solid composition. Preferably, the vulcanization is between 25° C. and 95° C. Preferably, the soy meal is in a particle form and is exposed to an air stream to separate the materials from the soy meal. Preferably (a) the soy meal and the water; and (b) the natural rubber, the accelerator and the sulfur are blended in an extruder to provide the blend of step (a). Also, preferably (i) the soy meal and the water, and (ii) the natural rubber, sulfur and accelerator are blended together in a mixer to provide the blend of step (a). Preferably the composition is as a fiber band or tube. In still further embodiments, the blend further comprises a compatibilizer. In further embodiments, the compatibilizer is calcium sulfate dihydrate (CSD).

The present invention relates to a method for the preparation of a prepared granular soy meal which comprises providing a granular natural soy meal containing dispersed non-thermoset materials associated with soy beans; and blowing a gas through a stream of the granular natural soy meal to remove the non-thermoset materials which are lighter than the granular soy meal to remove the non-thermoset materials and to provide the prepared granular soy meal. Preferably, the gas is air under ambient conditions. Preferably, the composition is as film, band or tube.

### BRIEF DESCRIPTION OF THE DRAWINGS

FIGS. 1 and 2 show the principle (FIG. 1) and image (FIG. 2) of the wind-blowing method.

FIGS. 3 and 4 show images of films from two fractionations. The purified SM powder is SSMP. FIG. 3 shows an image of film from impurities. FIG. 4 shows an image of film from purified soy meal.

FIG. 5 is a graph of an extrusion force/time curve of SSMP/Water mixture (4:1 w/w) at various processing temperature. Extrusion speed is 20 rpm; sample weight in every extrusion is 12 g.

FIG. 6 is a scheme showing the preparation of tough film by a two-step method. Note: NRV—natural rubber/vulcanization compounds premix, its recipe is shown in Table 3; MBT-2-Mercaptobenzothiazole.

FIG. 7 is a graph showing a determination of scorch time of SSMP/NRV blends at 75° C. and 90° C. with a motor speed of 20 rpm, respectively.

FIG. 8 is a graph showing a determination of scorch time for SSMP/NRV 75° C. and 90° C. by use of N-tert-butyl-2-benzothiazolesulfenamide (TBBS) as an accelerator. Screw speed=20 rpm. The recipe are the same one as shown in Table 5 and 6 except of accelerator.

FIG. 9 is a schematic diagram of processing bio-rubber bands of the present invention.

FIGS. 10 and 11 are images of Soy/bio-rubber bands. FIG. 10 is an image of the soy/bio-rubber band of the present invention having 51 wt % dry SSMP (3.0 mm×3 m). FIG. 11 shows the use of the soy/bio-rubber band of the present invention to bind plants/grasses.

FIG. 12 is a scheme showing the preparation of sheet, film, tube and band by use of an industrial extruder.

FIG. 13 is a graph showing stress/strain curves of the soy meal-based rubber band cured in a water bath at 90° C. for 20 min, and then stored at ambient conditions for 4 h, and commercial rubber bands.

FIG. 14 is a sectional view of the DSM extruder. When the gate is closed, the screws pump the melt from the chamber via the gate, through the groove and back to the chamber again; when the gate is open, the screws pump the melt from the chamber via the gate, through the die and out of the extruder; the feed amount is 10-12 g per experiment.

FIG. 15 is a graph showing TGA thermograms of dried SSMP, SSMP and SSMP/W (80/20) samples. Dried SSMP: SSMP was dried at 80° C., 1 mmHg for 10 h and then stored in a desiccator containing CaSO₄.

FIG. 16 is a graph showing the effects of curing time on storage modulus of the uncured soy meal-based rubber bands.

FIGS. 17A-F illustrate SEM images of (FIG. 17A) SN47.2-CSD (500×), (FIG. 17B) SN47.2-CSD (1500×), (FIG. 17C)SN48.7 (500×), (FIG. 17D) SN48.7 (1500×), (FIG. 17E) extended SN47.2-CSD (500×), and (FIG. 17F) extended SN54.5 (500×).

FIGS. 18A-C illustrate DMA diagrams of (A) NR, (B) SN48.7, (C)SN47.2-CSD, (D) SN54.2 and (E) SMT. (FIG. 18A) storage modulus, (FIG. 18B) loss modulus, (FIG. 18C) tangent delta.

FIG. 19 is a schematic diagram for preparing vulcanized soy meal-natural rubber blends. ZnO: zinc oxide; SA: stearic acid; NR-natural rubber; SM: soy meal; SMNR: soy meal-natural rubber; ZDEC: zinc diethyldithiocarbamate.

### DETAILED DESCRIPTION OF THE INVENTION

All patents, patent applications, government publications, government regulations, and literature references cited in this specification are hereby incorporated herein by reference in their entirety. In case of conflict, the present description, including definitions, will control.

Soy meal: The soybean processing industry in Michigan, after extraction of oil from soybeans, sells the residual soy meal at a price of ˜180 US$/ton (˜8 cents/lb.) for animal meal. Such inexpensive soy meal is converted in to value-added product of commercial attraction by the present invention.

Low cost and biodegradable blends from soy meal and natural rubber were first prepared in an extruder. The blends can be shaped into band, film, sheet and tube. Secondly, the blends were vulcanized and became elastic and stable. A bio-rubber band with commercial potential was also prepared.

Natural rubber-based biodegradable polymer: The price of natural rubber (1.16˜1.43 $/kg for Standard Malaysian Rubber (SMR)) is cheaper than that of low density polyethylene (LDPE, 1.47˜1.69 $/kg). In addition, natural rubber is a bio-based and biodegradable natural polymer but LDPE is not. Therefore, natural rubber has a potential for developing low cost biodegradable polymers. Ezoe first blended natural rubber (67 wt %) and starch, carboxymethylcellulose, coagulant, lecithin, casein, water soluble fertilizers in an extruder, and then vulcanized the blends to prepare biodegradable articles for binding pot soil in the field of agriculture (U.S. Pat. No. 5,523,331 to Ezoe). But the content of natural rubber is difficult to be equal or lower than 50% because there was no enough plasticizer for starch or carboxymethylcellulose, which would make the blends difficult to process if starch or carboxymethylcellulose content reached a high level. The processing conditions and strength of the blends, the most important data, were not given in that patent. Katuaki directly blended natural rubber (60 wt %) and corn protein to prepare biodegradable thermoplastic in an extruder (Katuaki, M. Japanese Patent, P2001-288295A, 2001). But the blends will have leaching problem because of the presence of much amount of plasticizers such as glycerol. In addition, the blends will be very sticking because natural rubber was not vulcanized. To improve the flexibility of thermoplastic starch, 2.5-20% of natural rubber was blended into starch matrix in an intensive mixer at 150° C. (Carvalho, A. J. F.; Job, A. E.; Alves, N.; Curvelo, A. A. S.; Gandini, A., Carbohydr. Polym. 2003, 53 (1), 95). Results revealed a reduction in tensile strength and a little improvement in flexibility.

Recently, we have found an effective way to overcome or improve the all above drawbacks. In the first stage, to decrease the cost of raw material, soy meal (SM) was used. But SM is impure and has bad processibility due to the presence of hulls and cellulose fibers. It is necessary to cheaply and efficiently remove these impurities from SM to prepare separated soy meal powder (SSMP). The SSMP should be pure enough to prepare transparent film. In the second stage, to extrude the SSMP in an extruder smoothly, optimal water content and temperature range should be designed according to the protein properties. In the third stage, natural rubber (NR) was blended with SSMP and vulcanized to prepare SSMP-rich material that has good flexibility even after drying and has promising water resistance. Because there is no any high boiling temperature plasticizer in the SSMP matrix, the SSMP/NR blend has no leaching problem. The blends can be shaped into bands, sheets, films, tubes and etc by use of an extruder.

Material: Natural rubber (SMR-CV60) was obtained as a gift from Harwick Standard Distribution Corporation (Ohio, USA). Soy meal was a gift sample from Michigan Soybean Promotion Committee (MSPC). The particle distribution of the soy meal is shown as follows: >2000 μm, 25.6 wt %; 1680-2000 μm, 13.1 wt %; 840-1680 μm, 56.9 wt % and <840 μm, 4.4 wt %. N-isopropyl-N′-phenylparaphenylenediamine (IPPD, SANTOFLEX® IPPD-PST-6MM), N-tert-Butyl-2-benzothiazolesulfenamide (PERKACIT® TBBS-GRS), and zinc diethyldithiocarbamate (PERKACIT® ZDEC-PDR) were obtained as gifts from Flexsys company (OH, USA). Stearic Acid (95%) and 2-Mercaptobenzothiazole (MBT, 98%) were purchased from Aldrich, USA. Zinc oxide (ZnO, 99.0%, powder) and sulfur (sublimed powder) was purchased from Columbus Chemical Industries Inc. (WI, USA).

Observation of leaching problem SSMP-NRV-70:50-U was compression-molded at 120° C. for 5 min into film. As control experiments, SSMP, 15 wt % of water and 15 wt % of sorbitol were molded to prepare sobitol-plasticized SSMP film. SPI, 20 wt % of water and 10 wt % of glycerol were molded to prepare glycerol-plasticized SPI film. Two hundred milliliters (200 mL) of distilled water was added into the bottom of an empty desiccator. Strip-like samples (10 mm×0.2 mm×100 mm) were placed on the screen of the desiccator and the desiccator was sealed to maintain relative humidity (RH) at 100%. Twenty-five hours later, the surfaces of the samples were inspected to evaluate the degree of leaching. A photo was also taken with the FinePix 4500 digital camera to record the results.

Water uptake test cured bars (3.0 mm diameter×100 mm) were weighed (W₀) and immersed in water. Twenty-four hours later, wet samples were dried with absorbing papers and weighed (W_{w}) for calculating water uptake (wt %) by use of the following equation.
Water uptake (wt %)=100×(W_{w}−W₀)/W₀ (1)

Tensile test Three series of sample were treated. The first samples were equilibrated at 24.5° C. and 60% relative humidity (RH) for 1 day (ambient state), and used for tensile test. The second ones were dried at 54° C. for 24 h (dry state), and used for tensile test. The third ones were immersed in distilled water for 24 h, then taken out and dried with absorbing papers and equilibrated at ambient conditions for 2 h before testing (wet state). Mechanical properties of the each of the three samples were tested using an Instron tensile tester (Instron 5565, USA). Initial grip separation was 50 mm, tensile speed was 50 mm/min, temperature was 25° C. and RH was 60%. Stress/strain curves were recorded to calculate strength at break (σ_{b}, MPa) and elongation at break (ε_{b}, %). For each treatment, at least four specimens were tested to calculate an average value and standard deviation.

Dynamic mechanical analysis (DMA) SSMP-NRV-70:50-U (1 g) was compression-molded at 55° C., 10 ton for 2 min to prepare a film. The film was cut into strip-like samples with dimensions of 4.3×15.6×0.16 mm³. DMA analysis of samples was conducted with a DMA Q800 dynamic mechanical analyzer (TA Instruments, Delaware, USA). A variable-amplitude, sinusoidal tensile stress (frequency=1 Hz) was applied to the sample to produce a sinusoidal strain of ±25 μm amplitude. Because vulcanization in practice is an isothermal process, samples were tested in an isothermal mode (90° C. for 240 min). Signals of storage modulus (MPa) and isotherm time (min) were recorded to draw storage modulus/time curves which were used to characterize the curing reaction of SSMP-NRV-70:50-U. Duplicate tests were conducted.

Thermal gravimetric analysis (TGA) was conducted using a thermal gravimetric analyzer (TGA 2950, TA Instruments, Delaware, USA) to measure the total weight loss of samples. Approximately 10 mg of sample was subjected to heating from 30° C. to 200° C. at 20° C./min in a nitrogen atmosphere (120 mL/min).

Preparation of separated soy meal powder (SSMP) Aim: purify soy meal to prepare homogeneous and transparent materials such as films.

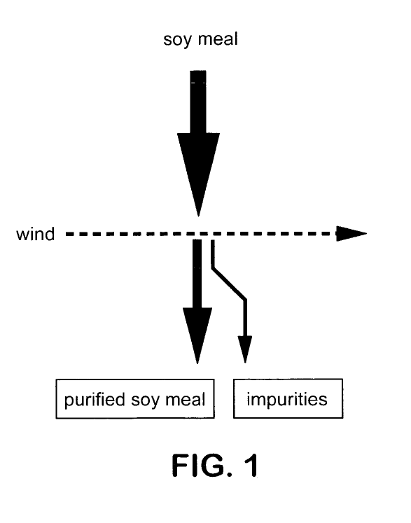

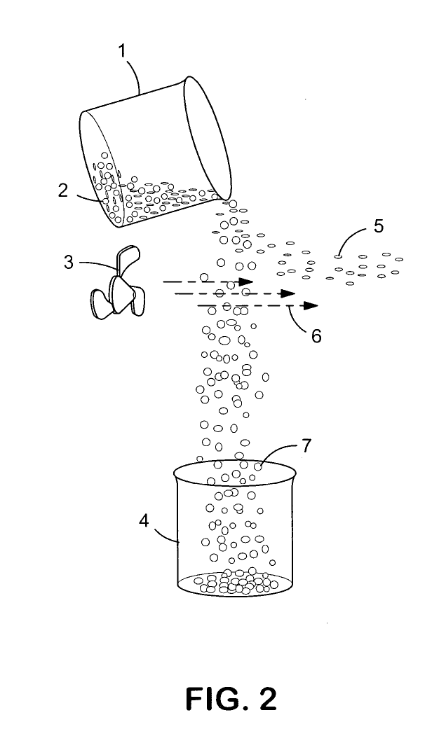

Method: A wind-blowing method was used to separate SM. This method is shown in FIGS. 1 and 2. In FIG. 2, the parts are as follows: (1) container; (2) raw soy meal; (3) blower fan; (4) collection container; (5) impurities; (6) air current; and (7) purified soy meal. The impurities are generally lighter than that of purified SM particles, so SM particles flow was separated in wind into two fractionations: purified SM and impurities. The purified SM was collected and separated again. The wind was produced from a hair drier. The two fractionations were milled in a mill (Cyclone Sample Mill, UDY Corporation, CO, USA) and the screen mesh was 297 μm. The milled and purified SM was SSMP that was fine powder. Film was prepared according to the followed procedure: pellets (6 g) were covered with Teflon films at both sides and the Teflon films were placed between two steel plates. The steel plates were placed between the two steel blocks of a hot press (Carver Laboratory Press, Model M, Fred S. Carver Inc, USA), whose temperature was controlled to be 125° C., and then was compression-molded at 1 ton for 1 min. After the premix was pre-heated, the pressure was quickly increased from 1 ton to 15 ton. 8 min later, the mold was cooled to below 50° C. by water-cooling system at a rate of 20° C./min. A yellow and transparent film with a thickness of 0.2 mm was released from the mold, and stored in a polyethylene bag. The extending area of film on the Teflon film was used to evaluate melt mobility. Generally, the area is the larger; the melt mobility is the better. A digital camera (FinePix 4500, Fuji Photo Co. LTD, Japan) was used to take a photo.

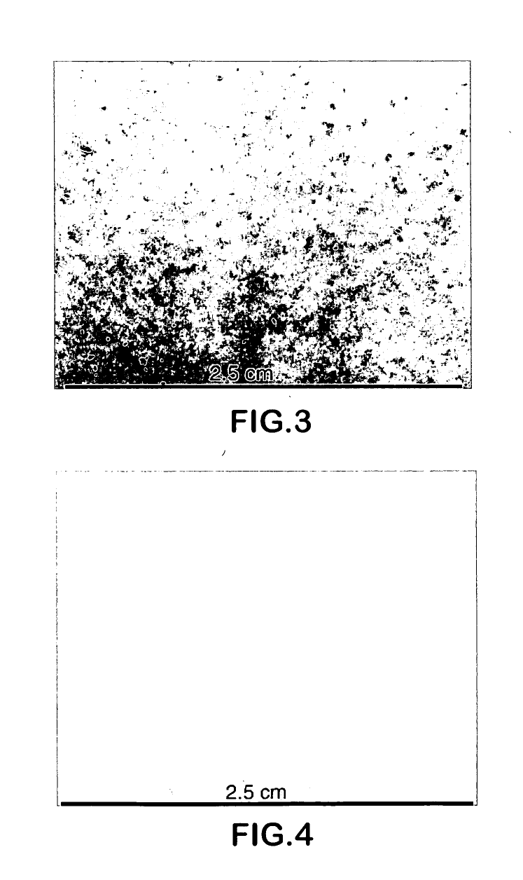

Results and Discussion: The percentages of purified SM and impurities are 87.2% and 12.8%, respectively. Each fractionation powder was mixed with 15% water and 15% sorbitol to prepare premix. The premix from purified SM was easily extruded. The premix from the impurity fraction was difficult to extrude. The extruder often stopped automatically because of too high a torque force for impurity sample. The area of compression-molded film from the impurity fractionation was much smaller than that from the SSMP, indicating the melt mobility of SSMP was better than that of impurity fraction. According to our observation, the impurity fractionation is composed of hulls, cellulose fibers and other foreign material, which mainly are non-thermoplastic. Therefore, the processing properties were rather poor. The images of films from two fractionations are shown in FIG. 3 (with impurities) and 4 (without impurities). There were many particles that could not be melted in the impurity fraction, but not in the SSMP fractionation. Where an automated machine is used to separate SM, SSMP can be pure.

Conclusion: Clearly, it is cheap and effective to separate SM by the wind-blowing method.

Optimization of Extrusion Conditions for SSMP Thermoplastic:

Aim: Raw SSMP is too difficult to extrude. It is necessary to design proper amount of water and proper extrusion temperature to make SSMP easy to extrude. Glycerol or sorbitol was not added into SSMP thermoplastic because they can cause a leaching problem.

Method: SSMP and water were mixed in a high-speed blender (Waring Commerical Blendor, model 34BL92, Dynamics Corporation of America, Connecticut, USA) for 1 min. to prepare a premix. The premix (12 g) was fed into a micro twin extruder (DSM research, Netherlands) to prepare the thermoplastic. The DSM extruder was equipped with a circle die with a diameter of 3.0 mm. Extrusion speed, temperature and average screw force were recorded. The extrusion force (N)/time (min) curves of SSMP/plasticizers mixture were also recorded. The morphology of extrudates was inspected.

TABLE 1
Effect of temperature on extrusion. Sample:
SSMP/Water = 80/20 (w/w), 20 rpm.

| | Average | | |
|---|---|---|---|
| Temperature | force | Extrudate | Mechanical |
| ° C. | (N) | properties | properties |
| 80 | 3500 | Coarse/yellow | Weak |
| 90 | 3100 | Smooth/yellow | Weak |
| 100 | 2950 | Smooth/yellow | Weak |
| 110 | 2800-7000 | Smooth/yellow | A little stiff |
| 120 | 4500-7000 | Smooth/black | A little stiff |
| 150 | >7000 | Coarse/black | Stiff |

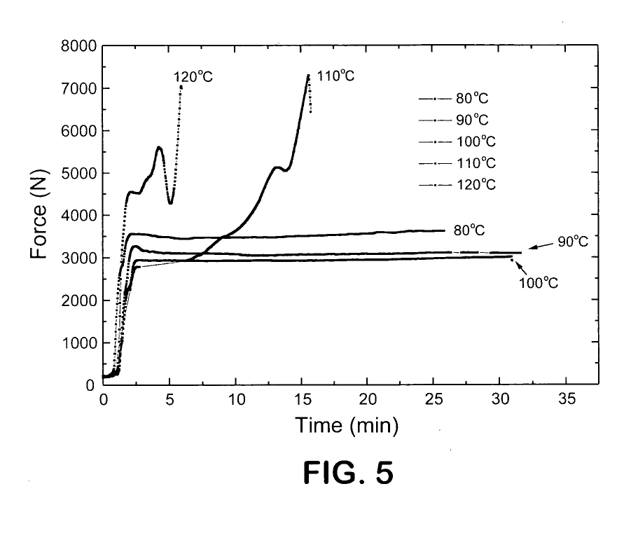

Results and Discussion: The effect of temperature on extrusion is shown in Table 1. Too high processing temperature (150° C.) evaporate water and the melt viscosity will increase. Low temperatures result in poor polymer mobility, also leading to higher extrusion force (3500 N at 80° C.). At a higher temperature (2950 N at 100° C.), the result was better. When barrel temperature was equal or higher than 110° C., water evaporated quickly and the extrusion force increased with increasing extrusion time as shown in FIG. 5. It can be concluded that an acceptable temperature for SSMP/water (4:1 w/w) is 80-100° C., and optimal processing temperature is 100° C.

The effect of water on extrusion is shown in Table 2. Too much water is a disadvantage for product and too low amount of water in SSMP will lead to high viscosity for processing. Rubber (NR) melt showed high viscosity when being processed, so SSMP/water mixture should have enough low melt viscosity in order to process SSMP/NR smoothly. According to the result from Table 2, 80/20 or 4:1 is an optimal ratio for processing SSMP/water mixture.

TABLE 2
Effect of water content on extrusion. Extrusion
conditions: temperature-100° C., motor speed 20 rpm. Water
content in this work is the percentage of water adding into
SSMP.

| | Average | | |
|---|---|---|---|
| SSMP/water | force | Extrudate | Mechanical |
| (g/g) | (N) | properties | properties |
| 70/30 | 1400 | Smooth/yellow | Weak |
| 80/20 | 2970 | Smooth/yellow | Strong and flexible |
| 90/10 | 6600 | Coarse/yellow | Stiff |

Conclusion: The optimal extrusion conditions are: temperature as 100° C., water content as 25%.

### EXAMPLE 1

Preparation of Flexible SSMP/NR Blends:

Aim: Un-vulcanized SSMP/NR blends are sticky and weak in strength. Vulcanization was necessary to prepare commercially valuable products from SSMP/NR blends. The aim of this experiment was to prepare SSMP/NR blends with high performance by use of vulcanization technology.

Preparation Tough Film by a Two-Step Method.

TABLE 3
Recipe of NRV (unit: g)

| | | | Stearic | | | |
|---|---|---|---|---|---|---|
| Name | NR | ZnO | acid | IPPD | Sulfur | MBT |
| Functions | matrix | activator | activator | antioxidant | crosslinker | accelerator |
| Weight | 100 | 5.0 | 2.0 | 2.0 | 1.5 | 1.5 |

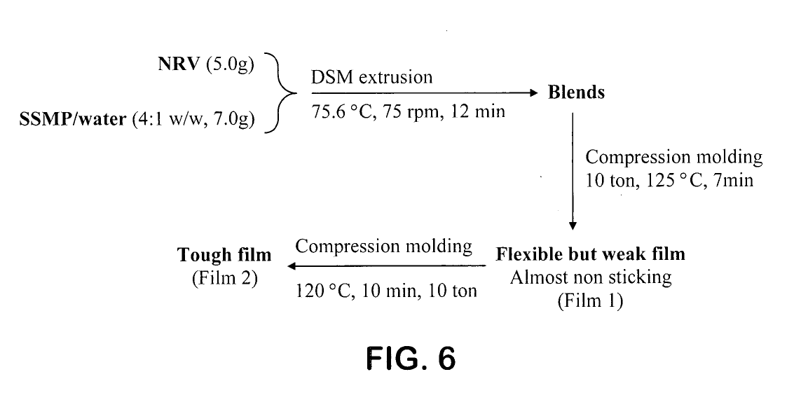

Results and discussion: Related method is shown in the scheme of FIG. 6, and the mechanical properties of the Film 1 and Film 2 are shown in Table 4. A weak film was prepared in the first compression molding (the first step) and then the toughness of the film was improved dramatically in the second molding (the second step).

TABLE 4
Film properties prepared by two-steps
methods in the scheme of FIG. 6.

| | | Strength | | |
|---|---|---|---|---|
| | | at break | Elongation | Film |
| Material | Processing method | (MPa) | at break (%) | properties |
| Film 1 | Extrusion blending, | 2.2 ± 0.5 | 205 ± 60 | Flexible but |
| | molding for | | | weak |
| | vulcanization | | | |
| Film 2 | Re-molding Film 1 | 17 | 87 | Tough |

Conclusion: We successfully prepared tough soy meal/natural rubber materials. The soy meal content in the material was as high as 50%. But the molding-remolding procedure is necessary to prepare this kind of tough material, which increases processing costs.

### EXAMPLE 2

Process Elastic Material with One Step (One Step Method).

As shown in the scheme of FIG. 6 and Example 1, in the first molding, cross-linking degree of the blends was so low that the mechanical properties of the blends were too weak. In the second molding, the cross-linking degree reached at a high level and tough blends were thus obtained. Therefore, cross-linking degree determines whether this material is tough or not. Accelerator types in a normal formulation mainly decide the amount of cross-linking degree. The accelerator we previously used is 2-mercaptobenzothiazole, which has a medium cure rate. On the basis of the above analysis, we selected an accelerator with fast cure rate. It is zinc diethyldithiocarbamate (ZDEC). This accelerator was used to prepare flexible blends by a simple method.

Preparation of NR/Vulcanization Compounds Blends (NRV)

Aim: To disperse vulcanization compounds into NR matrix

Method: NR and vulcanization compounds (VCs) were blended into NR/vulcanization compounds blends (NRV) at 75° C. for 8 min in the DSM extruder with a speed of 20 rpm. In ASTM3184-89, NR and VCs are mixed at 60° C. for 5 min. in a miniature intensive mixer, but the mixing ability of DSM extruder in a given period is weaker than an intensive mixer. Therefore, processing temperature and residence time were increased to 75° C. and 8 min for making VCs dispersed in NR homogeneously. The recipe of NRV is shown in Table 5. This recipe is recommended by two books (Coran, A. Y., In: Chapter 7, Vulcanization, Editors: Mark, J. E.; Erman, B.; Eirich, F. R., Science and Technology of Rubber Academic Press, CA, USA, 1994, p. 352 and Ciesielski, A., An Introduction to Rubber Technology, Publisher: PAPRA Technology Ltd. UK, 2000, p. 32).

TABLE 5
Recipe of NRV (unit: g).

| | | | Stearic | | | |
|---|---|---|---|---|---|---|
| Name | NR | ZnO | acid | IPPD | Sulfur | ZDEC |
| Functions | matrix | activator | activator | antioxidant | crosslinker | accelerator |
| | 100 | 5.0 | 2.0 | 2.0 | 2.0 | 1.5 |

Calculating scorch time of un-cured SSMP/NRV blends. Aim: The time lag between application of heat to raw rubber and the beginning of cure (scorch time) is a critical factor for a successful processing (Ciesielski, A., An Introduction to Rubber Technology, Publisher: PAPRA Technology Ltd. UK, 2000, p. 82). Calculating scorch time of un-cured SSMP/NR blends was this experimental aim.

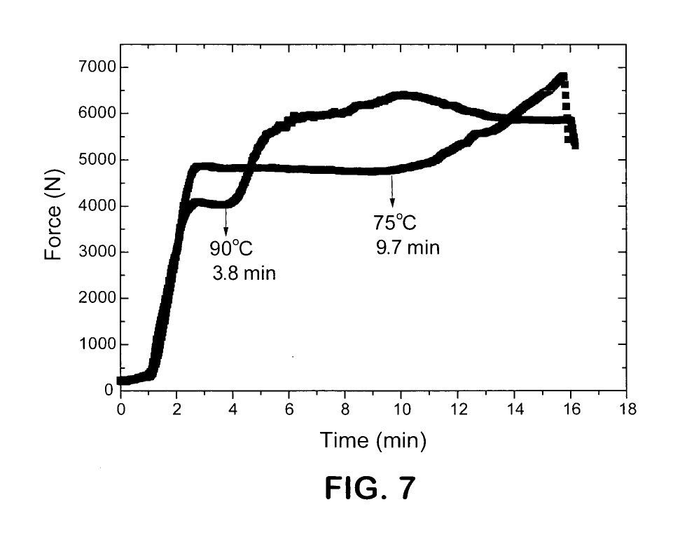

Method: In order to calculate scorch time of un-cured SSMP/NRV blends, SSMP/water (4:1 w/w) and NRV were blended at 75° C. at a motor speed of 20 rpm. The Recipe of un-cured SSMP/NRV blends was shown in Table 6. The torque (N)/time (min) curves of curing reaction (FIG. 7) were recorded by DSM computer system.

TABLE 6
Recipe of un-cured SSMP/NRV blends (unit: g).

| | Name | |
|---|---|---|
| | NRV | SSMP/water (4:1 w/w) |
| Weight | 5.0 | 7.0 |

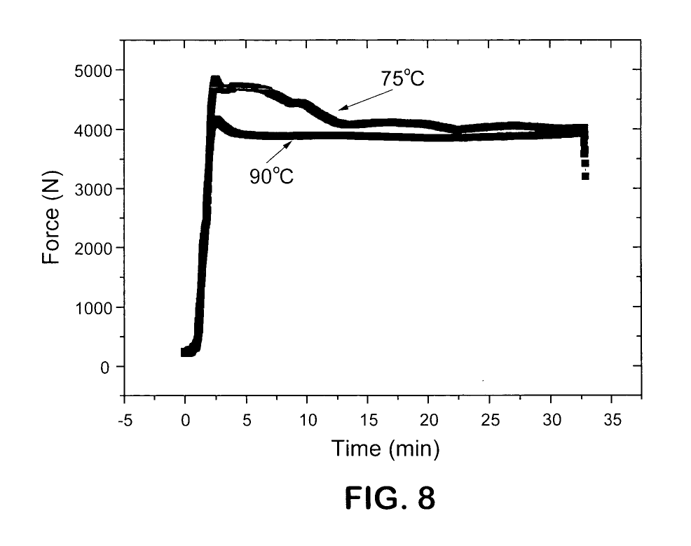

Results and Discussion: The scorch time at 90° C. is only 3.8 min, which is too short for dispersing SSMP thermoplastic into rubber phase. When mixing time is beyond 3.8 min, mixture in DSM extruder will cross-link quickly and DSM extruder has to stop immediately. There is no processing safety if un-cured SSMP/NRV blends were blended at 90° C. The scorch time at 75° C. was 9.7 min, which is enough for DSM to prepare homogeneous blends. Generally, scorch time can not be too short or too long. There is no processing safety for the blends with too short scorch time. There is a disadvantage for continuously processing for the blends with too long scorch time because blends cannot be quickly vulcanized after being extruded. Accelerator plays a key role in the vulcanization system. We have tried N-tert-Butyl-2-benzothiazolesulfenamide (TBBS) and 2-Mercaptobenzothiazole (MBT), but no exciting results were obtained. In FIG. 8, the scorch times of TBBS for SSMP/NRV blends both at 75° C. and 90° C. were longer than 33 min, which were too long for continuous processing.

Conclusion: ZDEC was the best accelerator candidate for developing flexible SSMP/NRV blends. We could process SSMP/NRV blends at 75° C. within 9.7 min and cure the blends at 90° C.

### EXAMPLE 3

Preparation of Un-Cured SSMP/NR Blends:

Method: 7.0 g of SSMP/water (4:1 w/w) and 5.0 g of NRV were blended in DSM extruder at 75° C. at a motor speed of 20 rpm. 8 min later, melt was extruded through the circle die of the extruder and cut into bars with a dimension of 3.0 mm diameter×100 mm. bars were packaged by aluminum foil separately and stored at 5° C. in a refrigerator.

Preparation of Cured SSMP/NR Blends:

Method: 12 hours later, bars (Un-cured SSMP/NR blends) were taken out of the refrigerator and put into an oven or water bath for vulcanization. Vulcanization temperature is 90° C., time is 20 min. After vulcanization, bars become strong, elastic and non-sticking compared with un-cured bars.

### EXAMPLE 4

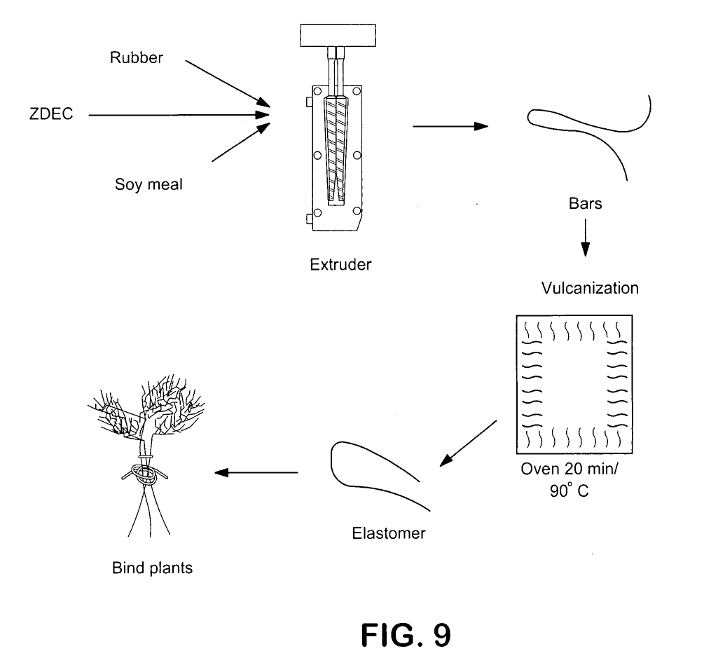

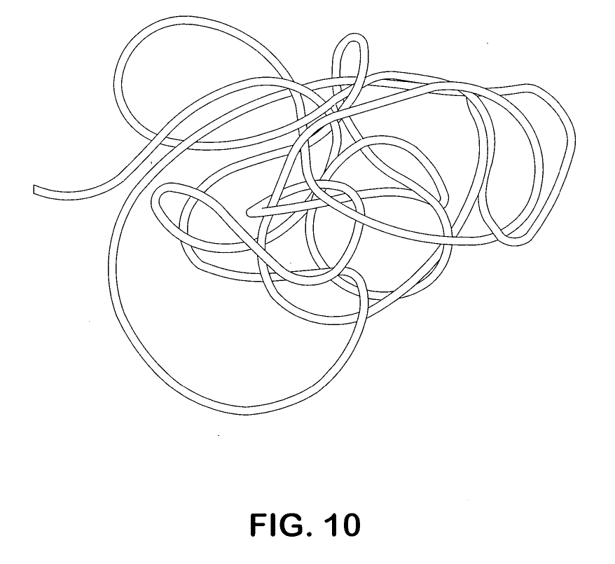

Example 4A. Because the DSM extruder we used was only equipped with a circle die, an example of preparing protein-based rubber bands is shown in the scheme of FIG. 9.

Mechanical properties of our rubber bands and commercial rubber bands are shown in Table 7. Under ambient conditions, our bio-rubber bands were weaker than commercial rubber bands, but became similar after wetting treatment as shown in Table 7.

Our bio-rubber bands have the following advantages: (1). Water resistant compared with soy meal; (2). Flexible or elastic under drying condition compared with soy meal; (3). Biodegradable; (4). Much lower in cost compared with polyethylene and commercial rubber bands; (5). Easy to process; (6). Cold resistant; (7). Lack of leaching problem due to that there is no other plasticizers than water in our bands.

Therefore, our bio-rubber bands can be used for replacing current commercial rubber bands in some applications. It can be used for binding flower and plant in agriculture (FIG. 11).

TABLE 7
Properties of our bio-rubber bands, commercial rubber bands and soy meal bands.

| | | | Ambient | | Dry | | Wet | |
|---|---|---|---|---|---|---|---|---|
| Name | SSMP^{a} | Water | σ_{b} | εb | σ_{b} | ε_{b} | σ_{b} | ε_{b} |
| Our bio-rubber bands | 51.0 | 6.7 ± 1.2 | 2.8 ± 0.2 | 357 ± 12 | 3.1 ± 0.1 | 399 ± 7 | 3.6 ± 0.8 | 478 ± 50 |
| Commercial Rubber bands | 0 | 1.1 ± 0.1 | 4.4 ± 0.5 | 396 ± 11 | 3.0 ± 0.3 | 381 ± 28 | 3.6 ± 0.2 | 456 ± 34 |
| Soy meal bands | 100 | 61.9 ± 3.5 | 7.0 ± 1.0 | 2.9 ± 0.4 | brittle | brittle | broken | broken |

^{a}12 g of SSMP/NRV blends contained 5.0 g of NRV and 7.0 g of SSMP/water (4:1). The moisture content of raw SSMP is 7.5 wt %. 7.0 g of SSMP SSMP/water (4:1) contained 1.82 g water and 5.18 g dry SSMP. Therefore, SSMP content in dry polymers is dry SSMP/(NRV + dry SSMP) × 100% = 5.18/(5.0 + 5.18) × 100% = 51.0 wt %.

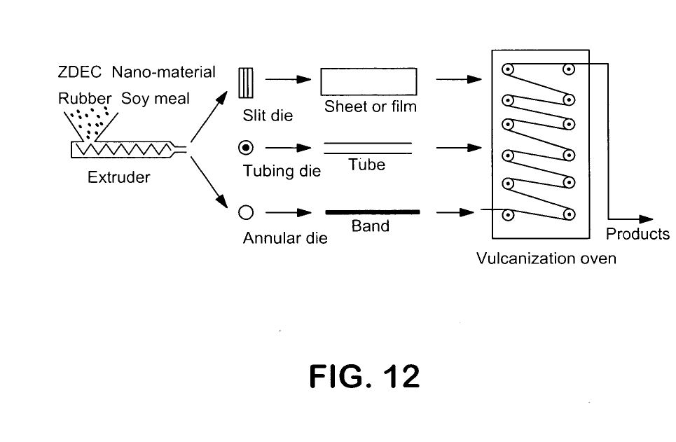

If the die of the micro-extruder in the scheme of FIG. 9 is changed into flat or tubing one, sheet, films or tubes can be easily produced by use of our soy meal/natural rubber blends. Therefore, our products are not limited to bio-rubber bands, bio-rubber sheet, film and tube also can be produced as shown in the scheme of FIG. 12.

Example 4B: The strength of our soy/bio-rubber bands (2.8 MPa) is weaker than that of commercial one (4.4 MPa). Rubber-based material has high heating resistance and the heating conduction ability of air in an oven is weak. This leads to the temperature of samples could not equilibrate as quickly as possible at 90° C. within 20 min, resulting in low cross-linking degree because the actual heating period of samples is much shorter than 20 min. Liquid has much better heating conduction ability than air, so in this example, water is used to heat sample to improve the mechanical properties of samples.

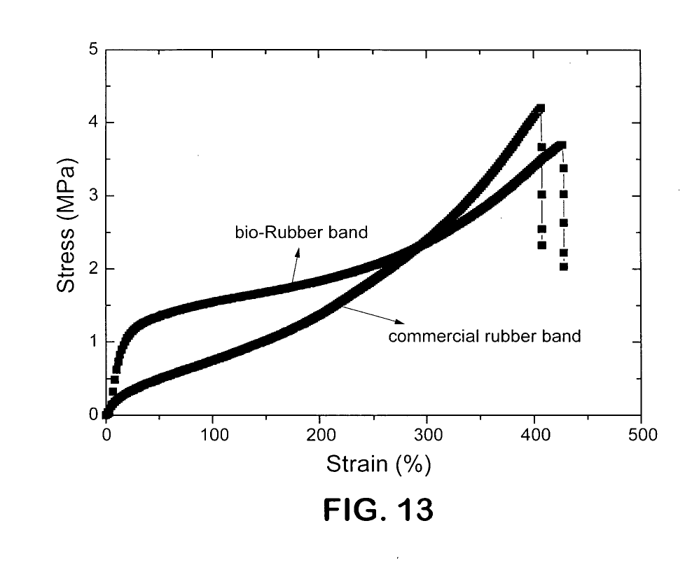

Un-cured bars were taken out from a refrigerator and vulcanized in a water bath with a temperature of 90° C. 20 min later, bars were removed from the water bath and a soft napkin was used to dry the cured bars. The stress/stain curves of the cured bars (bands) and commercial rubber bands are shown in FIG. 13. The mechanical properties of soy/bio-rubber bands cured in a water bath, soy/bio-rubber bands cured in an oven and commercial rubber bands are shown in Table 8.

TABLE 8
Properties of our bio-rubber bands,
commercial rubber bands and soy meal bands

| | σ_{b}^{a} | ε_{b} |
|---|---|---|
| Names | MPa | % |
| Our soy/bio-rubber bands cured in a water bath^{b} | 4.1 ± 0.5 | 420 ± 9 |
| Our soy/bio-rubber bands cured in an oven^{b} | 2.8 ± 0.2 | 357 ± 12 |
| Commercial Rubber bands | 4.4 ± 0.5 | 396 ± 11 |

^{a}samples were stored at ambient condition.
^{b}curing conditions: 90° C. and 20 min.

As shown in FIG. 13, the toughness of our soy/bio-rubber bands is similar with that of commercial rubber bands. The mechanical properties of our soy/bio-rubber bands cured in a water bath became better than that of one cured in an oven, thereby showing very similar properties with that of commercial rubber bands.

TABLE 9
Biodegradability in theory of our soy/bio-
rubber bands.

| | Weight | Mechanism of | Biodegradability |
|---|---|---|---|
| Components | Content (%)^{a} | biodegradability | type |
| SSMP | 51.0 | Food for microorganisms | Directly |
| | | | biodegradable |
| NR | 39.3 | Environmentally | First disposable |
| | | degraded by oxygen, | and then |
| | | ozone etc into | biodegradable |
| | | fractions, then | |
| | | degraded by | |
| | | microorganism | |
| Additives | 9.7 | Food for microorganisms | Directly |
| (ZnO, etc) | | | biodegradable |

^{a}12 g of SSMP/NRV blends contained 5.0 g of NRV and 7.0 g of SSMP/water (4:1). The moisture content of raw SSMP is 7.5 wt %. 7.0 g of SSMP SSMP/water (4:1) contained 1.82 g water and 5.18 g dry SSMP. Therefore, SSMP content in dry blends is dry SSMP/(NRV + dry SSMP) × 100% = 5.18/(5.0 + 5.18) × 100% = 51.0 wt %. The percentage of natural rubber in NRV is 100/125 × 100% = 80% (Table 5), the content of natural
rubber in dry blends is NR/(NRV + dry SSMP) × 100% = (5.0 × 80%)/(5.0 + 5.18) = 39.3%.

Discussion of the biodegradability of our bio-rubber bands: We did not test the biodegradability of our soy/bio-rubber bands, so there is no data as evidence. But we can predict the possible biodegradability of the product on the basis of existed knowledge. The biodegradability information in theory of our soy/bio-rubber bands is shown in Table 9. As it known, SSMP is a kind of food for microorganism, so this component will be biodegraded directly. There are many double bonds in NR macromolecular chains that are easy to be attacked and degraded by oxygen, ozone and water. When the molecular weight of the environmentally degraded NR is lower enough, microorganisms will start to use the NR fragments as food. Obviously, the biodegradability of cross-linked NR is depending on cross-linking degree. Tires in the car industry are difficult to degrade because of too high cross-linking degree and the presence of much amount of anti-microorganism additives. Commercial rubber bands are possible to degrade because of low cross-linking degree. If commercial rubber bands are stored in ambient conditions for 1-2 years, it will be sticky and lose its strength because of environmentally degradation. According to the elastic properties of our soy/bio-rubber bands, the cross-linking degree should be low enough for biodegradation.

Leaching Phenomenon of Protein-Based Polymers

After equilibration at 100% RH for 24 h, there was no leaching problem on the surface of the bio-rubber bands. But both sorbitol-plasticized SSMP film and glycerol-plasticized SPI film showed serious leaching problem. In most prior art patents, plasticizers with high boiling temperature, such as glycerol or polyol, incorporated into pure protein plastics (U.S. Pat. Nos. 5,710,190; 5,523,293 and 5,397,834 to Jane et al) or protein/synthetic polymer blends (U.S. Pat. No. 6,632,925 to Zhang et al). But the leaching problem has not been given much attention in these publications.

The present invention shows:

(1). The result that use of water as a plasticizer to prepare SSMP thermoplastic which has no leaching problem. In the available patents (U.S. Pat. Nos. 6,632,925 to Zhang et al; 5,710,190; 5,523,293 and 5,397,834 all to Jane et al) related to soy protein-based plastics, much amount of glycerol was used.

(2). Extrusion conditions of SSMP/water: SSMP/water from 90/10 to 70/30 w/w; temperature from 50 to 120° C. If SSMP is processed at high temperature, it will degrade and became black; and processing will became difficult because of the evaporation of water. In the available patents (U.S. Pat. Nos. 6,632,925 to Zhang et al; 5,710,190; 5,523,293 and 5,397,834 all to Jane et al) related to soy protein-based plastics, processing temperature is high than 120° C., which will lead to degradation of protein.

(3). Use low cost SM to prepare biodegradable and flexible SSMP/NR blends. In the available patents (U.S. Pat. Nos. 6,632,925 to Zhang et al; 5,710,190; 5,523,293 and 5,397,834 all to Jane et al) related to soy protein-based plastics, in the “Examples” section, only soy protein isolate is used because soy protein isolate has much better processibility than soy meal.

(4). Use ZDEC to vulcanize SSMP/NR to improve the toughness of the blends. ZDEC makes continuous processing possible because of its proper scorch time.

(5). SSMP content reached at a high level in blends. In the available patents (U.S. Pat. Nos. 6,632,925 to Zhang et al; 5,710,190; 5,523,293 and 5,397,834 all to Jane et al) related to soy protein-based plastics, dry soy protein content in dry polymers cannot reach at 50% or higher under the condition of good mechanical properties.

(6). Use a two-step method to prepare tough film. The strength of the prepared film was improved dramatically. Use to one-step method to continuously extrude SSMP/NR blend.

To prepare low cost, biodegradable, and elastic soy protein-based materials from the byproducts of the soy oil industry, soy meal particles were purified to prepare separated soy meal powder (SSMP). Then, the amount of water and extrusion temperature were optimized to improve the processability of SSMP. Finally, natural rubber and vulcanization compounds were blended with SSMP to prepare flexible blends. Results showed that wind blowing was a cheap and effective method to prepare SSMP. The processability of SSMP was obviously improved if incorporated water content was 20 wt % and extrusion temperature was 100° C. After vulcanization, SSMP/NR blends containing 51 wt % SSMP remained elastic (strength at break: 2.8-4.1 MPa, elongation at break: 350-540%) even after drying at 54° C. for 24 h or immersion in water for 24 hours. There was no leaching problem because there is no plasticizer other than water in the blends. The blends can be shaped into bands, film, sheet and tubes. A bio-rubber band was prepared as a product, which showed similar mechanical properties to those of commercial rubber bands (strength at break: 3.0-4.4 MPa, elongation at break: 396-456%). It is feasible to produce the bio-rubber bands, sheet and film on a large scale.

The relationship between material properties and processability of the novel soy meal/natural rubber blends were discussed. In the first stage, to decrease the cost of raw material, SM was used. But SM is impure and has poor processability due to the presence of hulls and cellulose fibers. It is necessary to cheaply and efficiently remove these impurities from SM to prepare separated soy meal powder (SSMP). In the second stage, to smoothly extrude the SSMP in an extruder, optimal water content and temperature range were determined. In the third stage, NR was blended with SSMP and vulcanized to prepare SSMP-rich material that has good flexibility even after drying and has promising water resistance. Because there is no plasticizer other than water in the SSMP matrix, the SSMP/NR blend has no leaching problem.

TABLE 10
Particle size distribution of soy meal

| Particle size, μm | wt % of sample |
|---|---|
| ≧ 2000 | 25.6 |
| 1680-2000 | 13.1 |
| 840-1680 | 56.9 |
| ≦ 840 | 4.4 |

### EXAMPLE 5

Experimental

Material: Natural rubber (SMR-CV60) was obtained from Harwick Standard Distribution Corporation, Akron, Ohio. Soy meal (7.5±0.7 wt % of moisture) was obtained from the Michigan Soybean Promotion Committee, Frankenmuth, Mich. The particle size distribution of the soy meal is shown in Table 10. N-isopropyl-N′-phenylparaphenylenediamine (IPPD, SANTOFLEX® IPPD-PST-6MM) and zinc diethyldithiocarbamate (PERKACIT® ZDEC-PDR) were obtained from Flexsys company, Akron, Ohio; stearic acid (95%) and sorbitol (industry grade) were purchased from Aldrich, St. Louis, Mo. Zinc oxide (ZnO, 99.0%, powder) and sulfur (sublimed powder) were purchased from Columbus Chemical Industries Inc., Columbus, Wis. and commercial rubber bands (size #33, Officemax®,) from Officemax Inc, Shaker Heights, Ohio.

Preparation of Separated Soy Meal Powder (SSMP)

In order to purify soy meal, a wind-blowing method was used. This method is shown in the scheme of FIGS. 1 and 2. The impurities were generally lighter than purified SM particles, so the SM particle flow was separated in wind into two fractions: purified SM and impurities. The purified SM was collected and separated again. The wind was produced from a hair drier (HIGHENERGY® 1250, Conair Corp., Edison, N.J.). The two fractions were milled in a mill (Cyclone Sample Mill, UDY Corporation, CO, USA) with a 297 μm screen mesh. The purified and milled SM, denoted SSMP, was a fine powder.

Preparation of Film by Compression-Molding

Samples (3 g) were covered with Teflon films on both sides and placed between two steel plates. The steel plates were placed in a hot press (Carver Laboratory Press, Model M, Fred S. Carver Inc, Menomonee, Wis.) at 125° C., and compression-molded at 1 ton for 1 min. Next, the pressure was quickly increased to 15 ton. After 8 min, the mold was cooled to below 40° C. by a water-cooling system at a rate of 10° C./min. A yellow transparent film with a thickness of 0.2 mm was released from the mold, and stored in a polyethylene bag.

Improvement of Processability of SSMP Thermoplastic

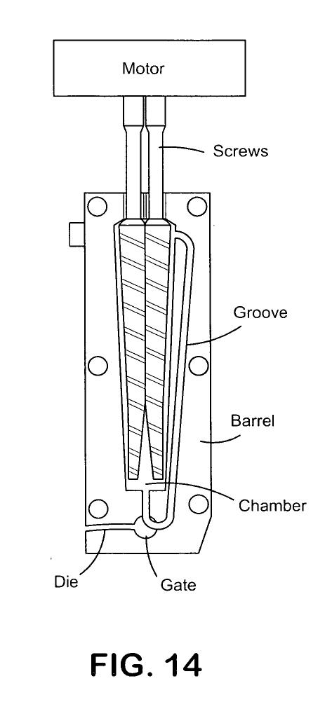

Raw SSMP is difficult to extrude. It is necessary to add water and use proper extrusion temperatures, to make SSMP easy to extrude. Glycerol or sorbitol will not be added into SSMP thermoplastic because they will cause leaching problems. The method used in the current study is described as follows: SSMP and water were mixed in a high-speed blender (Waring Commerical Blender, model 34BL92, Dynamics Corporation of America, New Hartford, Conn., USA) for 1 minute to prepare premix. The premix (12 g) was fed into a micro-twin extruder (15 cm³ in volume capacity, DSM Research, Netherlands) to prepare the thermoplastic. A diagram of the DSM extruder is shown in FIG. 14. The extrusion speed was kept constant at 20 rpm in this study unless indicated. The extrusion force was recorded, the extrusion force (N)/time (min) curves were used to evaluate the processability of SSMP/water mixtures. The morphology of the extrudates was also inspected. First SSMP with various incorporated water contents (10%, 20% and 30%) was fed into the DSM extruder and mixed at 100° C. for 25 min to obtain extrusion force/time curves. Incorporated water content was optimized in this step using the extrusion force/time curves. Next, SSMP with optimal incorporated water content was mixed at 80° C., 90° C., 100° C., 110° C., 120° C. and 150° C. Extrusion force/time curves at different processing temperatures were recorded to determine the acceptable or optimal processing temperature range. The optimized extrusion conditions were used for blending SSMP/NR.

Preparation of Flexible SSMP/NR Blends

SSMP/NR blends are sticky and weak. Vulcanization is necessary to prepare commercially valuable products from SSMP/NR blends. The detailed methods are as follows:

(1) Preparation of NR/vulcanization compound blends (NRV): To disperse vulcanization compounds into the NR matrix, NR and vulcanization compounds (VCs) were blended at 75° C. for 8 min in the DSM extruder to prepare NRV. In ASTM3184-89, NR and VCs are mixed at 60° C. for 5 min. in a miniature intensive mixer, but the mixing ability of the DSM extruder is less than an intensive mixer. Therefore, the processing temperature and residence time were increased. The recipe for NRV is shown in Table 11.

TABLE 11
Recipe for NRV

| Name | Function | Weight (g) |
|---|---|---|
| NR | matrix | 100 |
| ZnO | activator | 5.0 |
| Stearic acid | activator | 2.0 |
| IPPD | antioxidant | 2.0 |
| Sulfur | cross-linker | 2.0 |
| ZDEC | accelerator | 1.5 |

(2) Calculating scorch time of un-cured SSMP/NRV blends: The time lag between application of heat to rubber and the beginning of cure (scorch time) is a critical factor for successful processing (An Introduction to Rubber Technology; Ciesielski, A., Ed.; PAPRA Technology Ltd.: UK, 2000; p. 82). In order to calculate the scorch time of un-cured SSMP/NRV blends, the sample was blended at 75° C. and 90° C. The weight ratio of SSMP/water (80/20 w/w) to NRV blends was kept constant at 7.0/5.0 (g/g) in this study unless otherwise specified. Extrusion torque (N)/time (min) curves of mixing were recorded by the DSM computer system.

(3). Preparation of uncured SSMP/NRV blends: SSMP/W (80/20, 7.0 g) and NRV (5.0 g) were blended in the DSM extruder at 75° C. 6 min later, melt was extruded through the circular die of the extruder and cut into bars with dimensions of 3.0 mm diameter×100 mm. The bars were packaged separately in aluminum foil and stored at 5° C. in a refrigerator. The uncured SSMP/NRV blends was coded as SSMP-NRV-70:50-U, in which “70:50” stands for the weigh ratio of SSMP/water (80:20) to NRV and ‘U’ represents “un-cured”. SSMP-NRV-70:50-U is a thermoplastic which can be shaped into various articles such as bands, sheet, film, tubes, etc. SSMP-NRV-70:50-U (36 g) was shaped into a band with the dimensions of 3.0 mm (diameter)×3 m (length)

(4). Preparation of cured SSMP/NR blends: 24 h later, SSMP-NRV-70:50-U was taken out of the refrigerator and put into an oven or water bath for vulcanization. Vulcanization temperature was 90° C. and time was 20 min. Cured SSMP/NR bars were coded as SSMP-NRV-70:50-C. Bands made from this material are referred to as “bio-rubber bands”.

Evaluating purity of SSMP: In order to investigate the purity of the each fraction as shown in the scheme of FIG. 1. Each fraction was first mixed with sorbitol (15 wt %) and water (15 wt %) in the Waring Commerical blender for 30 seconds to prepare a premix. The premix was compression-molded into film. The transparency of the film was inspected by use of a digital camera (FinePix 4500, Fuji Photo Co. LTD, Japan) to evaluate the purity of the film. If film from the soy meal fraction is transparent by vision inspection and satisfies with general packaging, this soy meal fraction is considered as purified soy meal; or else, as impurities. The premixture was also extruded in the DSM extruder to evaluate the processability of the fractions.

Results and Discussion

Preparation of separated soy meal powder (SSMP): The percentages of purified SM and impurities were 87.2 wt % and 12.8 wt %, respectively. The premixture from purified SM was easy to extrude but that from the impurities fraction was difficult. The extruder often stopped automatically because of excessive torque force. The impurities fraction was inspected by vision and appeared to be composed of hulls, cellulose fibers and other foreign material. The processing properties were rather poor. Images of films from the two fractionations are shown in FIGS. 3 and 4. There were many particles that could not be melted in the impurities fraction, but only a few in the SSMP fraction. If a machine is used to separate SM automatically and repeatedly, it is expected that the SSMP will become successfully pure. To prepare soy protein isolate from soy meal, soy meal is treated with hydroxyl sodium and hydrochloric acid aqueous solution. Then the SPI precipitate is dried to prepare powder (Soy protein products: characteristics, nutritional aspects, and utilization; Endres, J. G., Ed.; AOCS Press: IL, USA, 2001). SPI shows higher strength than SM, but is expensive because a large amount of chemicals, water and energy are used in the purification process. Obviously, it is cheap and effective to separate SM by the wind-blowing method. It should be noted that the method employed in this study, while effective, is crude. A commercial process would use one of a variety of readily available classification systems (Wright, D. J.; Bumstead, M. R.; Chan, H. W. J. Food Sci. Agric. 1984, 35, 531) and (Sessa, D. J., J. Food Sci. Agric. 2004, 84, 75).

Improvement of Processability of SSMP Thermoplastic

TABLE 12
Effects of incorporated water content on the processability of SSMP thermoplastic.

| | Incorporated | | | | |
|---|---|---|---|---|---|
| | water content | Average force | Maximum force | | |
| Samples | (%) | (N)^{a} | (N)^{a} | Extrudate surface | Mechanical properties |
| SSMP/W (70/30) | 30 | 1400 | 1523 | Smooth/yellow | Weak |
| SSMP/W (80/20) | 20 | 2970 | 3019 | Smooth/yellow | Strong/flexible |
| SSMP/W (90/10) | 10 | 6600 | 7500 | Coarse/yellow | Stiff |

^{a}extrusion force displayed by the DSM extruder.
Note:
temperature is 100° C. and motor speed is 20 rpm. Water content in this work is the percentage of water by weight added into SSMP.

The effects of incorporated water content on the processability of SSMP thermoplastic are shown in Table 12. Too much water was a disadvantage for product properties, while too low an amount of water in SSMP led to an excessively high viscosity for processing. Rubber melt has a high viscosity when being processed, so the SSMP/water mixture should have a low enough melt viscosity in order to process the SSMP/NR smoothly. On the basis of the above considerations, 20 wt % of water should be incorporated into SSMP to make extrusion smooth.

TABLE 13
Effects of temperature on the processability of SSMP
thermoplastic.

| Temperature | | | Mechanical |
|---|---|---|---|
| ° C. | Average force | Extrudate surface | properties |
| 80 | 3500 | Coarse/yellow | Weak |
| 90 | 3100 | Smooth/yellow | Weak |
| 100 | 2950 | Smooth/yellow | Weak |
| 110 | 2800-7000 | Smooth/yellow | Somewhat stiff |
| 120 | 4500-7000 | Smooth/black | Somewhat stiff |
| 150 | >7000 | Coarse/black | Stiff |

Note:
sample is SSMP/W (80/20) and motor speed is 20 rpm.

Processing temperature dramatically affected processability of SSMP thermoplastic, as shown in Table 13. Too high a processing temperature (150° C.) caused water to evaporate and melt viscosity to increase. Low temperature resulted in poor mobility of the polymer, also leading to higher extrusion forces (3500 N at 80° C.). When barrel temperature was equal to or higher than 110° C., water evaporated quickly and extrusion force increased with increasing extrusion time as shown in FIG. 5. Because of degradation, the extrudate became black in color after the sample was processed at 120° C. for 6 min or 150° C. for 30 seconds. When the sample was processed in the extruder at 150° C. for 30 seconds, the extruder stopped due to high melt viscosity. As shown in FIG. 5, extrusion forces of samples processed at temperatures above 100° C. were sensitive to extrusion time (residence time), but the extrusion force remained constant when processing temperature was equal to or under 100° C. It can be concluded that an acceptable extruding temperature for SSMP/W (80/20) is 80-100° C., and the optimal processing temperature is 100° C.

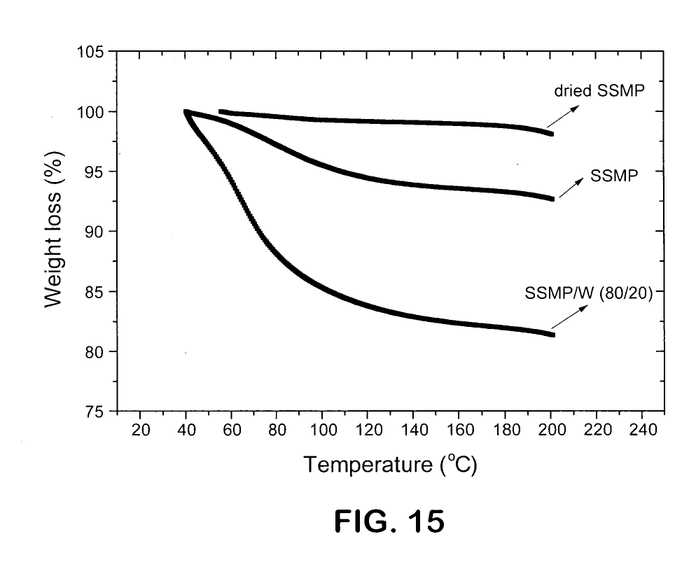

TGA thermograms of dried samples of SSMP, SSMP and SSMP/W (80/20) are shown in FIG. 15. Because the processing temperature of SSMP in practice is below 200° C., the scanning temperature range of TGA in FIG. 15 was from ambient temperature to 200° C. Even when SSMP was dried at 80° C., 1 mmHg for 10 h (FIG. 15, dried SSMP), it still absorbed about 1 wt % moisture during storage and handling. The weight loss of both SSMP and SSMP/W (80/20) was significantly dependent on extruding temperatures from 30-120° C. but after 120° C., this trend declined. This implies that water was completely evaporated after 120° C. Therefore, the optimal processing temperature should be equal to or below 100° C. to avoid obvious weight loss of water in processing. Concomitant with the complete loss in water content, the extrusion force increased sharply when SSMP/W (80/20) was extruded at 120° C., as shown in FIG. 5. SSMP started to become black in color as shown in Table 13, indicating thermal degradation. FIG. 15 shows no obvious degradation reaction for dried SSMP. These results implied that the time-temperature history is significantly less severe in the TGA test than in extrusion.

Preparation of Flexible SSMP/NR Blends

The formulation of vulcanization compounds used in this work is shown in Table 11. This is a typical formulation for accelerated sulfur vulcanization systems (An Introduction to Rubber Technology; Ciesielski, A., Ed.; PAPRA Technology Ltd.: UK, 2000; p. 82) and (Coran, A. Y., Vulcanization. In Science and Technology of Rubber; Mark, J. E.; Erman, B.; Eirich, F. R., Eds.; Academic Press: CA, 1994; pp. 350-352). When the sulfur content is larger than 2.0 g/100 g NR, sulfur will blossom on the surface of the sample, and when the ZDEC content is larger than 2.0 g/100 g NR, there are odor problems. Hence, the contents of sulfur and ZDEC were selected as 2.0 g/100 g NR, and 1.5 g/100 g NR, respectively. This is a Semi-Efficient Vulcanization (EV) system (Bhowmick, A. K.; Mangaraj, D., Vulcanization and curing techniques. In Rubber Products Manufacturing Technology; Bhowmick, A. K.; Hall, M. M.; Benarey, H. A., Eds.; Marcel Dekker Inc.: New York, 1994; pp. 320-340).

In this work, the SSMP/NRV premix was mixed in the DSM extruder, and screw torque as a function of time was recorded to calculate scorch time. This is a kind of on-line measurement which is little different from a standard method described in ASTM D2084-88, in which the sample is not mixed but is in static state in a cavity. Therefore, the method using the DSM extruder is more useful than the standard one for simulating the extrusion situation. As shown in FIG. 7, the scorch time of SSMP-NRV-70:50-U at 90° C. was only 3.8 min, which is too short for dispersing SSMP thermoplastic into the rubber phase. When the mixing time was beyond 3.8 min, the mixture in the DSM extruder would cross-link quickly and the DSM extruder had to stop immediately. There was no processing safety if uncured SSMP/NRV blends were blended at 90° C. The scorch time at 75° C. was 9.7 min, which is enough for the preparation of homogeneous blends. Generally, scorch time cannot be too short or too long. There is no processing safety for the blends with too short scorch time. There is a disadvantage for continuous processing for the blends with too long a scorch time because blends can not be quickly vulcanized after being extruded. The accelerator plays a key role in the vulcanization system. At present, there are four main types of accelerators: benzothiazole, benzothiazolesulfenamides, dithiocarbamates and amines (Coran, A. Y., Vulcanization. In Science and Technology of Rubber; Mark, J. E.; Erman, B.; Eirich, F. R., Eds.; Academic Press: CA, 1994; pp. 350-352). In these accelerators, we first tried 2-Mercaptobenzothiazole (MBT) and N-tert-Butyl-2-benzothiazolesulfenamide (TBBS), which are common accelerators in the rubber industry, but the scorch times both at 70° C. and 90° C., respectively, were longer than 35 min (curves are not shown), which were too long for a continuous extrusion process. Therefore, we tried dithiocarbamate type accelerators which have the fastest curing rate and shortest scorch time among the current accelerators (Coran, A. Y., Vulcanization. In Science and Technology of Rubber; Mark, J. E.; Erman, B.; Eirich, F. R., Eds.; Academic Press: CA, 1994; pp. 350-352). Among the dithiocarbamate type accelerators, ZDEC gave better results than tetramethylthiuram disulfide (TMTD) in this study. In summary, SSMP/NRV blends could be extruded at 75° C. within 9.7 min, and the extrudates could be cured at 90° C. However, more details study could be done on the selection of accelerators.

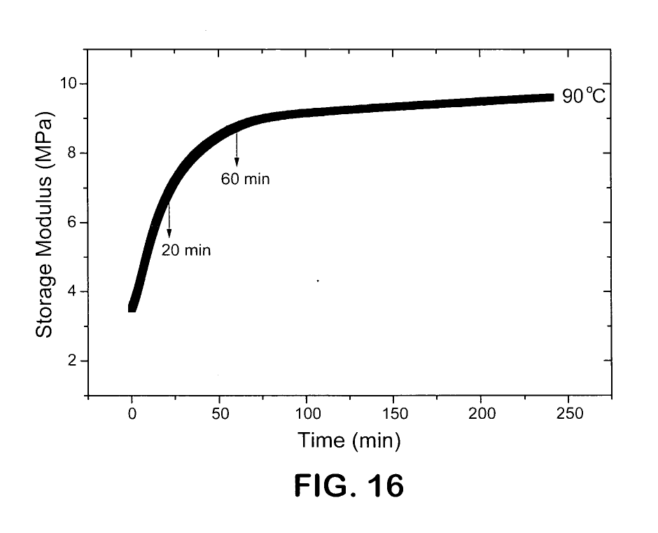

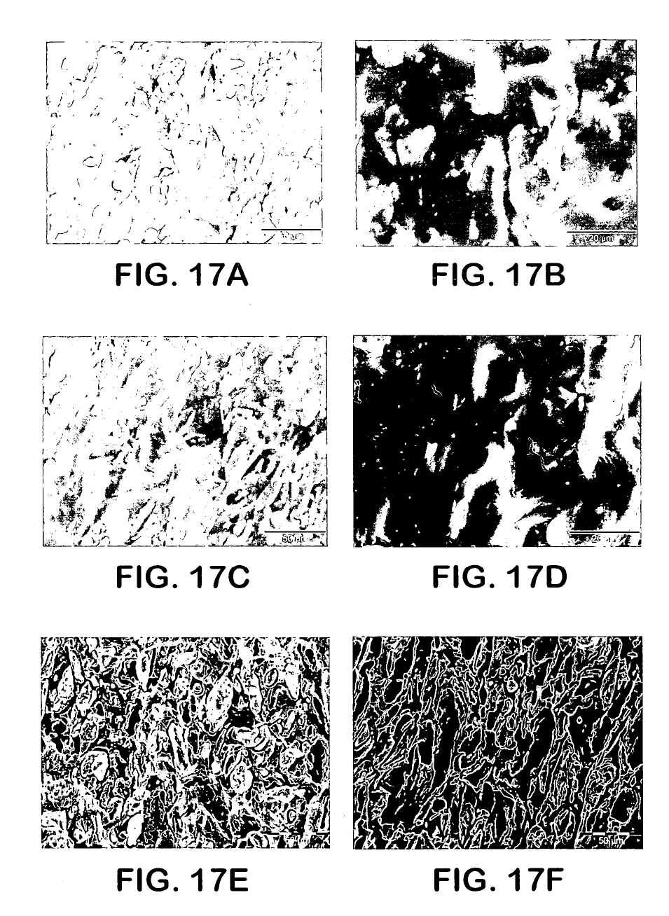

In order to determine the effect of curing time on the mechanical properties of SSMP-NRV-70:50-C, DMA was used to monitor the curing reaction as shown in FIG. 16.

There is a direct relationship between the small strain modulus and the crosslink density for rubber. Therefore, the state of cure can be monitored by use of DMA in isothermal mode. In FIG. 16, the storage modulus of the sample increased quickly in the first 60 min but slowly after 60 min. The storage modulus increased to 55.9% of its final value. Increasing the curing time to 60 min. is beneficial to increasing toughness but this will increase processing cost. To prepare a tough sample, one strategy is to optimize the vulcanization formulation, which will be done in future work. Another strategy is first to cure samples at 90° C. for 20 min., and then continue to cure at ambient conditions, since the sample has an ability to cure slowly at ambient conditions. Film from SSMP thermoplastic was brittle and film from NRV without SSMP was weak in strength (σb=0.47), so these two samples failed during DMA measurement in the tension mode.

Mechanical properties of SSMP-NRV-70:50-C vulcanized in an oven at 90° C. for 20 min., are shown in Table 14. Commercial rubber bands (Officemax®) and SSMP thermoplastic from SSMP/W (80/20) were used as controls. Fresh SSMP thermoplastic tended to become brittle at ambient conditions because of the loss of water. This made the thermoplastic broken when tightened in the clamps of the Instron tensile tester. Accordingly, fresh SSMP thermoplastic was stored in a sealed glass bottle and the bottle was placed in a refrigerator at 5° C. to avoid the growth of microorganisms. Even under these storage conditions, SSMP thermoplastic also showed a little brittleness (εb=2.9%). When dried in an oven, SSMP thermoplastic was too brittle to test. When immersed in water for 24 h, SSMP thermoplastic absorbed 61.9% water, which resulted in failure for the tensile test. These results indicate that SSMP thermoplastic is rather limited in use. At ambient conditions, commercial rubber bands showed better mechanical properties than SSMP-NRV-70:50-C, but after drying at 54° C. for 24 h, σb and εb of commercial rubber bands decreased to 3.0 MPa and 381%, respectively, due to thermal degradation. After immersion in water, the commercial rubber bands absorbed 1.1% water and became more elastic compared with those stored at ambient conditions. SSMP-NRV-70:50-C after drying showed better mechanical properties than at ambient conditions because the material was still actively in cross-linking reaction during drying (54° C., 24 h). Both σb and εb of SSMP-NRV-70:50-C immersed in water for 24 h increased, compared with this values for samples at ambient conditions. This is an adverse phenomenon because the mechanical properties of wetted samples should become worse. A possible explanation was that: before immersion in water, vulcanization compounds such as stearic acid, ZDEC etc., were heterogeneously distributed in the hydrophobic NR matrix. Especially for ZDEC, it is water soluble and high hydrophilic. It would exist in the NR matrix in the form of micro-particles. When SSMP-NRV-70:50-C was immersed in water, water would penetrate the NR matrix slowly, dissolve the hydrophilic micro-particles and redistribute them. The re-distribution would make ZDEC has more chances to interact with hydrophobic sulfur. This would trigger new cross-linking reactions, resulting in improvement in the mechanical properties of SSMP-NRV-70:50-C. Water is beneficial for ZDEC to accelerate vulcanization reaction. In the natural rubber glove industry, ZDEC is often used to speed up the curing of aqueous latex in products (Gorton, R., Latex product manufacturing technology. In Rubber Products Manufacturing Technology; Bhowmick, A. K.; Hall, M. M.; Benarey, H. A., Eds.; Marcel Dekker Inc.: New York, 1994; pp. 823).

After curing at 90° C. for 90 min, σb and εb of SSMP-NRV-70:50-C were improved to 4.0±0.3 MPa and 750±11%, respectively. The results proved that increasing curing time resulted in the improvement of mechanical properties as shown in FIG. 16 (DMA curves).

TABLE 14
Properties of SSMP-NRV-70:50-C, commercial rubber bands (Officemax ®) and soy meal
thermoplastic

| | SSMP | | Ambient^{b} | | Dry^{c} | | Wet^{d} | |
|---|---|---|---|---|---|---|---|---|
| | content^{a} | Water uptake | σb | εb | σb | εb | σb | εb |
| Samples | % | % | MPa | % | MPa | % | MPa | % |
| SSMP-NRV- | 51.0 | 6.7 ± 1.2 | 2.8 ± 0.2 | 357 ± 12 | 3.1 ± 0.1 | 399 ± 7 | 3.0 ± 0.3 | 540 ± 30 |
| 70:50-C | | | | | | | | |
| Officemax ® | 0 | 1.1 ± 0.1 | 4.4 ± 0.5 | 396 ± 11 | 3.0 ± 0.3 | 381 ± 28 | 3.6 ± 0.2 | 456 ± 34 |
| bands | | | | | | | | |
| SSMP | 100 | 61.9 ± 3.5 | 7.0 ± 1.0 | 2.9 ± 0.4 | brittle | brittle | broken | broken |
| thermoplastic | | | | | | | | |

^{a}SSMP content is dry SSMP/(NRV + dry SSMP) × 100%.
^{b}Samples were stored at ambient conditions.
^{c}Samples were dried at 54° C. for 24 h.
^{d}Samples were immersed in water for 24 h, then equilibrated at ambient conditions for 2 h.

The strength of SSMP-NRV-70:50-C (2.8 MPa) was less than that of commercial rubber bands (4.4 MPa). Rubber-based material has low thermal conductivity and the heat conduction ability of air in an oven is low. This reduces the amount of cross-linking because the effective cross-linking time for the samples is actually much shorter than 20 min., due to the time required for heating. Liquid has much better heating conduction ability than air, so the sample bars were first cured in a water bath at 90° C. for 20 min., and then stored at ambient conditions for 4 h. The stress/strain curves of the SSMP-NRV-70:50-C cured in water bath and commercial rubber bands are shown in FIG. 13. SSMP-NRV-70:50-C cured in a water bath showed similar mechanical properties (σb4.1±0.5 MPa, εb=420±9%) to commercial rubber bands (σb=4.4±0.5 MPa, εb=396±11%). This result implies that SSMP-NRV-70:50-C can replace commercial rubber bands in some applications.

It is a challenge to prepare low cost and elastic soy protein-rich blends. Interestingly, SSMP-NRV-70:50-C containing no glycerol remained elastic at ambient conditions, when dry and when wet. This indicates the structure of this material plays an important role. In the future work, the research focusing on the material structure should be done.

SSMP-NRV-70:50-U contained 15.2 wt % of water in theory, which is a disadvantage for curing because water will boil and produce bubbles in the sample if the curing temperature is higher than 100° C. Therefore, the curing temperature should be lower than 95° C. to avoid the production of bubbles. However, this disadvantage may become an advantage if blends are extruded to prepare foam at high temperatures, where water is a useful foam-forming agent.

Feasibility for Production on a Large Scale

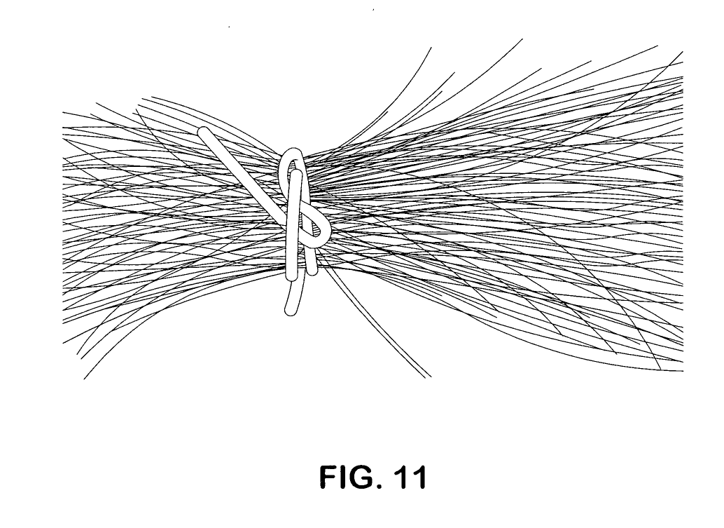

A white bio-rubber band with a length of 3 m was successfully produced by the use of the same processing method as that used on SSMP-NRV-70:50-C, and vulcanized in an oven at 90° C. for 20 min. In FIG. 10, this bio-rubber band is elastic and can be used as a substitute for commercial rubber bands. Potential uses could include the binding of flowers, vegetables or trees.

If slit or annular dies are used, sheets, films or tubes can be easily produced from soy meal/natural rubber blends as shown in the scheme of FIG. 12. Therefore, products are not limited to bio-rubber band.

The extruder in the scheme of FIG. 12 should have good mixing ability to homogeneously blend hydrophilic SSMP and hydrophobic NR. A pin extruder used in the rubber industry may be a satisfactory candidate because of its excellent ability to disrupt rubber at a low processing temperature (Iddon, M. I., Extrusion and extrusion machinery. In Rubber Products Manufacturing Technology; Bhowmick, A. K.; Hall, M. M.; Benarey, H. A.; Eds.; Marcel Dekker Inc.: New York, 1994, pp. 296).

Biodegradability of SSMP/NRV Blends

As is known, SSMP is a food for microorganism, so this component will be biodegraded directly. There are many double bonds in NR macromolecular chains that are easily attacked and degraded by oxygen, ozone and water. When the molecular weight of the environmentally degraded NR is low enough, microorganisms will start to use the NR fragments as food. Obviously, the biodegradability of cross-linked NR is dependent on the degree of cross-linking. Automobile tires are difficult to degrade because of their high degree of cross-linking and large amount of anti-microbial additives (Thorn, A. D.; Robinson, R. A. Compound design. In Rubber Products Manufacturing Technology; Bhowmick, A. K.; Hall, M. M.; Benarey, H. A.; Eds.; Marcel Dekker Inc.: New York, 1994; pp. 55). Commercial rubber bands are degradable because of their low degree of cross-linking. If commercial rubber bands are stored at ambient conditions for 1-2 years, they become sticky and lost their strength because of environmental degradation. Bode et al. (Bode, H. B.; Kerkhoff, K.; Jendrossek, D., Biomacromolecules 2001, 2, 295) reported that raw NR, NR latex gloves and synthetic isoprene rubber were biodegradable. After 6 weeks of incubation, the molecular weight distribution of the three materials showed a significant shift to a lower value. It is necessary to evaluate the biodegradability of the SSMP/NRV blends by use of standard biodegradability test methods.

Leaching Phenomenon of Protein-Based Polymers

After equilibration at 100% RH for 24 h, there was no visible leaching problem on the surface of films made from SSMP-NRV-70:50-U. But both sorbitol-plasticized SSMP films and glycerol-plasticized SPI films showed serious leaching problems. This is because at low relative humidity, protein molecular chains can fully interact with sorbitol or glycerol. Therefore, sorbitol and glycerol will not migrate from a protein matrix under low RH conditions. At high RH conditions, a protein matrix will absorb moisture from the environment, leading to an increase in water content in the protein matrix. The protein macromolecules will interact with water in preference to sorbitol or glycerol. Some of the sorbitol or glycerol molecules become free because of the loss of interaction, and migrate out of the protein matrix. Finally, liquid blossoms on the surface of the film, as evidence of the leaching problem. But the leaching problem has not been given much attention in most publications. (U.S. Pat. Nos. 6,632,925 to Zhang et al; 5,710,190 to Jane et al; 5,523,293 to Jane et al and 6,045,868 to Rayas et al).

Wind-blowing is a low cost and effective way to purify soy meal. Based on the results herein, the optimal extrusion conditions for SSMP are: 20% water and a processing temperature of 80-100° C. ZDEC made it possible for the SSMP/NRV blend to be processed at 75° C. and cured at 90° C. The bio-rubber band with 51 wt % SSMP was elastic, water resistant, without leaching problems and possessed similar mechanical properties to commercial rubber bands. Furthermore, it is possible to continuously produce low cost bands, sheets, films and tubes in an extruder. The results indicate that the technology has a potential for practical application.

### EXAMPLE 6

In this example, experiments were conducted to improve the soy meal-natural rubber blend (SMNR) blend. When the SMNR is exposed to water, the color of the water changed to yellow. This indicates that the application of such a blend in water-sensitive application might contaminate the water system. One of the accomplishments in this example is that we are successful in finding out the source of this problem and solved the problem. The N-isopropyl-N′-phenylparaphenylenediamine (IPPD, an antioxidant) than we used during blending process was found to be the source of this water coloring problem. An IPPD-free SMNR blend showed similar properties to the blend that contains IPPD, with the added advantage of elimination of the water coloring problem. This important finding increases the commercial value of the products.

Experimental.

Studies on a Drawback of the Soy Meal-Natural Rubber Blends (SMNR): The problem addressed is that when the soy meal-natural rubber blends are immersed in water for two days, the color of the water become yellow. This problem might be a concern for widespread applications of the developed SMNR blend in water sensitive type applications.

TABLE 15
Composition of the rubber compounds in the SMNR blends and effects of IPPD
on the water color of the blends

| | | | | | | | Tensile | | |
|---|---|---|---|---|---|---|---|---|---|
| Sample | NR | ZnO | SA | IPPD | S | ZDEC | Strength | Elongation | Color of |
| Number | (g) | (g) | (g) | (g) | (g) | (g) | (MPa) | (%) | Water |
| 1 | 25 | 1.25 | 0.5 | 0.5 | 0.5 | 0.38 | 2.6 ± 0.1 | 347 ± 8 | Yellow |
| 2 | 25 | 1.25 | 0.5 | 0 | 0.5 | 0.38 | 2.5 ± 0.2 | 343 ± 10 | Colorless |

NR: natural rubber; SA (activator): stearic acid; S (crosslinker): sulfur; ZDEC (accelerator): zinc diethyldithiocarbamate; IPPD (antioxidant): N-isopropyl-N′-phenylparaphenylenediamine.

Analysis: This problem indicated that some chemicals leached out from the developed SMNR blend. After we carefully checked the color of each compound in the blends, IPPD was suspected to be the source of this problem. The following experiment was designed to prove the hypothesis.

Experiments: Two different SMNR blends: one containing IPPD and second one containing no IPPD (IPPD-free) were prepared by DSM extrusion. The other compositions for the two blends were same as shown in Table 15. The two blends were immersed in water for 2 days to observe the color change of the water.

Results: The compositions of the rubber compounds are shown in Table 15. The soy meal (SM) content in the blend was 60%, and the rubber system (rubber+vulcanization compounds) content was 40%. The water used for immersing SMNR blends having IPPD is yellow, while the water used for immersing SMNR blends without IPPD is colorless. Since the water used for immersing SMNR blends without IPPD did not show any coloration, this indicates that the this system is superior over the one with IPPD.

Conclusion: This yellow color was due to the presence of IPPD. The two samples showed similar strength and elongation.

Finding a Compatibilizer for Soy Meal and Natural Rubber Blends: As described in this example, a safe, inexpensive and efficient compatibilization system for SMNR blend was developed successfully. Calcium sulfate dihydrate (CSD) as a compatilizer improved the properties of the blends. CSD is a safe, inexpensive and efficient compatilizer for the blend. Calcium sulfate dihydrate (CSD) can interact with protein macromolecules and has been used as a physical cross-linker in many applications (S. K. Par, C. O. Rhee, K. H. Bae, N. S. Hettiarachchy, J. Agri, Food. Chem. 2001, 49(5): 2308-2312). In our SMNR blends, soy meal contains about 40% protein. Natural rubber is terminated with protein domains with a protein content of 2% (F. W. Barlow, in “Rubber compounding principles, material and technology”; Marcel Dekker Inc.: New York, 1993; p 15). It is expected that CSD can interact with the protein in the Soy Meal (SM) as well as with the protein in the natural rubber. Again CSD is safe, cheap (less than one cent per pound, see http://minerals.usgs.gov/minerals/pubs/commodity/gypsum/gyps umyb04.pdf; access date: Mar. 24, 2006), and stiff. The detailed cost analysis may find some interesting results.

Processing to Prepare the SMNR Blend in the Presence of the Compatibilizer: In this study we made IPPD-free SMNR blend by using the above mentioned formulations (Table 15). In order to study the effect of compatibilizer (calcium sulfate dihydrate, CSD) we made a IPPD-free SMNR blend that contained 5 wt. % CSD.

TABLE 16
Effect of CSD Compatilizer on the Properties of SMNR
blends

| | CSD content | Extrusion | Tensile Strength | Elongation |
|---|---|---|---|---|
| Sample | (%) | Force (N) | (MPa) | (%) |
| 1 | 0 | 4200 | 2.6 ± 0.2 | 347 ± 11 |
| 2 | 5 | 4500 | 3.0 ± 0.2 | 356 ± 5 |

Results and Conclusion from this Study: As shown in Table 16, in presence of 5% CDS the elongation improves by 2.6% while tensile strength improves by 15.4%. Thus the incorporation of an inexpensive material (here CSD) in the final targeted formulation of SMNR can provide improved properties with some additional commercial benefit over uncompatibilized SMNR blends.

Fabrication of Sheets and Bands Using Pilot-Scale Twin-Screw Extruder and a Two-Roll Mill.

Preparation of IPPD-free Sheets and Bands: The IPPD-free SMNR non-cured blends were made using a twin-screw extruder. In this extrusion process, soy meal, natural rubber, ZnO and stearic acid were extruded at 120° C. Such extruded SMNR blends were then processed (70° C.) in two roll mill. In this two roll mill processing step we added sulfur and ZDEC. After this step the blended products: (a) compression molded to make sheets or (b) extruded to make bands.

Results: Sheet and the bands as developed show commercial importance. The product is likely not to cause the yellow color problem after being immersed into water.

Application of the Soy Meal Natural Rubber (SMNR) blends: We have successfully processed our soy meal natural rubber blends using banbury mixer, extruder and roller mill. The developed SMNR blends can find applications in the following areas: 1. Tubing or cords for single use. (See the pictures in the web: http://www.simolex.com/html/tubing.html); 2. Bands to replace commercial rubber bands; 3. Sheets used as pads, etc.; 4. Moldable articles such as container, tray, etc.; and 5. Elastic rope for binding. However, the SMNR is not limited to these applications.

In summary, more experiments were conducted to improve the SMNR blend further more. We found a problem of the developed soy meal-natural rubber (SMNR) blend. The problem is that when SMNR exposed to water, the color of the water changed into yellow. This indicates that the application of such blend in water-sensitive application might contaminate the water system. One of the accomplishments is that we are successful in finding out the source of such problem and solved this problem. N-isopropyl-N′-phenylparaphenylenediamine (IPPD, an antioxidant) that we used during blending process was found to be the source of this water coloring problem. IPPD-free SMNR blend showed similar properties to the blend that contains IPPD with added advantage of elimination of water coloring problem. This important progress is that a safe, inexpensive and efficient compatibilization system for SMNR blend was developed successfully. Calcium sulfate dihydrate as a compatilizer improved the properties of the blends. This work is discussed further in Example 7.

### EXAMPLE 7

This example deals with further developmental work. In the earlier examples, the prepared soy meal-natural rubber blend (SMNR) showed many advantages such as low cost, high soy meal content, and flexibility etc. In this example, more experiments were conducted to further improve the SMNR blend. A Banbury mixer was used to process the SMNR blends and results showed that it is effective to use a mixer to prepare the soy meal-natural rubber blends to obtain higher strength as compared to extrusion processing.

As discussed in Example 6, a problem of the developed soy meal-natural rubber (SMNR) blend was found. When the SMNR is exposed to water, the color of the water changed to yellow. This indicates that the use of such blends in water-sensitive applications might contaminate water systems. We were successful in finding out the source of the problem and solving it. The N-isopropyl-N′-phenylparaphenylenediamine (IPPD, antioxidant) that we used during the blending process was found to be the source of the water discoloration. IPPD-free SMNR blends showed similar properties to the blends that contain IPPD with the added advantage of elimination of the water discoloration problem. This important finding increases the commercial value of the products.

The IPPD-free SMNR blends were processed by extrusion and roll-milling. The procedure is shown as follows: (1) soy meal, water, zinc oxide, and stearic acid were first extruded at about 95° C. to prepare soy meal thermoplastic; (2) the thermoplastic and natural rubber were extruded at 85-130° C. to prepare blends; (3) the blends were mixed with sulfur and ZDEC at 70° C. for 6-10 min by roll-milling, to prepare prevulcanized SMNR sheets; (4) the prevulcanized sheets were vulcanized by compression-molding or heating in an oven to prepare final products. Results showed that it is possible to use the above procedure to process the SMNR blends and the prepared products such as sheet, bands, and trays showed potential in practice.

Another important progress is that a safe, inexpensive and efficient compatibilization system for SMNR blend was successfully developed. Calcium sulfate dihydrate as a compatilizer improved the properties of the blends.

Advantages of this invention: 1. IPPD-free SMNR blend showed similar properties to the blend that contains IPPD with the added advantage of elimination of water discoloration; 2. It is possible to process the soy meal and natural rubber into products with high quality and commercial potential by use of pilot-scale plastics equipment such as extruders and roll mills; and 3. Calcium sulfate dihydrate was a safe, inexpensive and efficient compatibilization system for the SMNR blend.

Experiments.

Materials: Natural rubber (SMR-CV60) was obtained from Harwick Standard Distribution Corporation (Akron, Ohio). Soy meal was obtained from the Michigan Soybean Promotion Committee (Frankenmuth, Mich.). The moisture content of the soy meal was 7.5 +0.7 wt %. The average particle size of the soy meal was 1.5 mm in diameter. Zinc diethyldithiocarbamate (PERKACIT® ZDEC-PDR) and N-isopropyl-N′-phenylparaphenylenediamine (IPPD, SANTOFLEX® IPPD-PST-6MM) were obtained from Flexsys company (Akron, Ohio). Stearic acid (95%) and calcium sulfate dihydrate (CSD) were purchased from Aldrich (St. Louis, Mo.). Zinc oxide (ZnO, 99.0%, powder) and sulfur (sublimed powder) were purchased from Columbus Chemical Industries Inc. (Columbus, Wis.).

Sample 1: Kinetic Mixer Processing.

Experiments: A homogeneous mixture can be obtained using a Banbury mixer due to its high shear capability. Soy meal and water (4:1, g/g) were charged into a Banbury mixer (Plastic-corder® PL-V151, 50 mL, C. W. Brabender Instrument Inc. Hackensack, N.J.) and mixed at 60° C. for 5 min to prepare soy meal thermoplastic. The soy meal thermoplastic and natural rubber were mixed in the mixer at 60° C. for 5 min to form a blend. The blend was shaped into band-like samples by use of a DSM micro-extruder at 70° C. with a screw speed of 50 rpm. Stress-strain curves were investigated using an Instron tensile tester.

Results and discussion: The properties of the samples are summarized in Table 17. In our previous work, the blend with same composition processed only using the DSM micro-extruder showed a strength of 2.8 MPa and an elongation of 357%. This is described in U.S. patent application Ser. No. 11/200,593 (U.S. Patent Application Publication No. 2006/0041036) to Mohanty et al., incorporated herein by reference in its entirety. In this work, the sample showed higher strength (4.5 MPa) and lower elongation (198%). Due to the high shear, soy meal thermoplastic and the natural rubber were mixed homogeneously, possibly resulting in higher cross-linking density of the sample 1. Therefore, it is effective to use a mixer to prepare the soy meal-natural rubber blends.

TABLE 17
Properties of the vulcanized soy meal-natural
rubber blend prepared by Banbury mixing

| | Weight ratio | Soy meal | | | | |
|---|---|---|---|---|---|---|
| | of SM to | content in | | | | |
| Samples | Water | the blends % | Method | σ_{b} MPa | ε_{b} % | Comments |
| 1 | 4:1 | 51 | Banbury | 4.5 ± 0.6 | 198 ± 5 | Improved |
| | | | mixing | | | strength |

TABLE 18
Composition of the rubber compounds in the SMNR blends and effects
of IPPD on the color of water after the blends exposed in water.

| | | | | | | | | Properties of the blends | | |
|---|---|---|---|---|---|---|---|---|---|---|
| | | Composition of the rubber compounds | | | | | | Tensile | | |
| | SM | NR | ZnO | SA | IPPD | S | ZDEC | Strength | Elongation | Color of |
| Samples | (%) | (g) | (g) | (g) | (g) | (g) | (g) | (MPa) | (%) | Water |
| 2 | 60 | 25 | 1.25 | 0.5 | 0.5 | 0.5 | 0.38 | 2.6 ± 0.1 | 347 ± 8 | Yellow |
| 3 | 60 | 25 | 1.25 | 0.5 | 0.0 | 0.5 | 0.38 | 2.5 ± 0.2 | 343 ± 10 | Colorless |

SM: soy meal; NR: natural rubber; SA (activator): stearic acid; S (crosslinker): sulfur; ZDEC (accelerator): zinc diethyldithiocarbamate; IPPD (antioxidant): N-isopropyl-N′-phenylparaphenylenediamine.

Samples 2-3: Effect of IPPD.

Experiments: Two different SMNR blends, one containing IPPD (Sample 2) and the second containing no IPPD (IPPD-free, Sample 3), were prepared in the DSM extruder. The extrusion temperature was 75° C. and the extrusion speed was 50 rpm. The two blends were immersed in water for 2 days to observe the color change of the water. The compositions and the properties of the two samples are shown in Table 18.

Results and discussion: The sample containing IPPD (Sample 2) shows yellow discoloration of the water while the IPPD-free blend (Sample 3) did not show any discoloration, indicating the latter system is superior. The two samples had similar strength and elongation. It is concluded that the yellow discoloration of the blends was due to the presence of IPPD.

Samples 4-9: Processing the IPPD-Free Blends Using a Pilot Scale Twin-Screw Extruder and a Roll Mill.

Preparation of natural rubber (NR) small pieces: Natural rubber blocks were cut into small pieces and processed at 70° C. in a roll mill for 8 min to prepare rubber sheet. The sheet was cut into small pieces (about 5 mm×5 mm×10 mm) using scissors. A minimal amount of starch powder (<0.5 wt % on the rubber weight basis) was mixed with the sticky rubber for preparing non-sticky rubber cylinders.

Preparation of purified soy meal: Soy meal particles were purified using our previous wind-blowing method. The yield of the purified soy meal and residues were calculated on the base of the total weight of the two fractionations.

Preparation of soy meal (SM) thermoplastic: The weight ratio of the purified soy meal particles to water was kept constant at 4:1. The purified soy meal (1500 g), water (375 g), ZnO (67 g) and stearic acid (27 g) were mixed together to prepare a premix. CSD was added depending on the formulation. The premix was extruded through two die holes (3 mm diameter for each) in an extruder (ZSK-30, Werner & Pfleiderer, Ramsey, N.J.) to prepare soy meal thermoplastic. The extrusion speed was 60 rpm, the barrel temperature profile was 98/98/98/98/98/94° C., the melt temperature was 103° C., the maximal torque was 75% and the melt pressure was 3.9 MPa.

Preparation of SMNR thermoplastic: The rubber small pieces were not easily fed into the extruder using an automatic feeder. Therefore, the rubber small pieces and the soy meal pellets were pre-mixed in a plastic cup and fed by hand into the extruder using the cup. The feed rate was 60 g/min. The die of the ZSK-30 extruder was removed due to high torque if the die was fixed on the extruder. The outlet size of the extruder was 62 mm×9 mm. The extrusion speed was 60 rpm, the barrel temperature profile from the feed throat to the die was 100/97/100/100/100/95° C. The melt temperature ranged from 100 to 105° C., the maximal torque was 80% and the melt pressure was about 0.7 MPa.

Preparation of prevulcanized SMNR blends: Details are shown in ASTM D3182-89. The SMNR thermoplastic (910.0 g) was first warmed at 70° C. in a roll mill (Serial No. 13381, Bolling roll mill, Seewart Bolling & company, Cleveland, Ohio) for 7 min, then sulfur (7.4 g, cross-linker) and ZDEC (6.0 g, accelerator) were added into the SMNR warm matrix within 2 min. After mixing at 70° C. for 7 min, prevulcanized SMNR sheet was successfully prepared.

Preparation of vulcanized SMNR blends: The prevulcanized SMNR sheets were vulcanized by compression-molding at 100° C., 20 ton for 10 min to prepare vulcanized sheet. The dimensions of the sheet were 167.0 mm×167.0 mm×2.6 mm. Four samples were molded and coded as SN54.5, SN48.7, and SN47.2-CSD. The “SN” represents soy meal-natural rubber and the following number is the content of soy meal. The “CSD” in the SN47.2-CSD represents calcium sulfate dihydrate. The prevulcanized SMNR sheet was also vulcanized in an oven at 90° C. for 10 min to prepare one sample (SN54.5-oven). As control, soy meal incorporated with 25 wt % of water on a total weight basis was extruded and compression-molded into sheets to prepare soy meal thermoplastic (SMT).

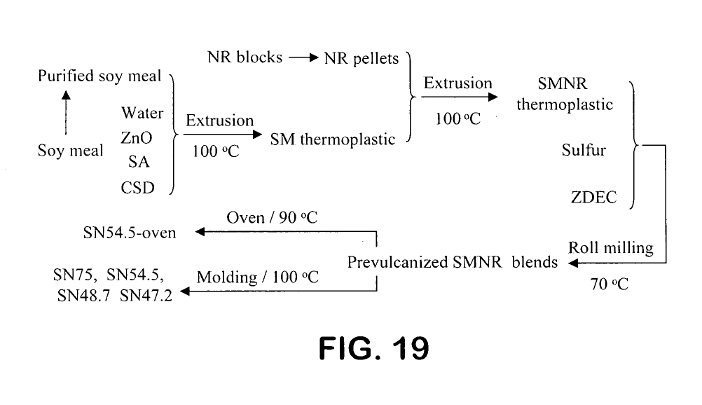

The above processing procedure is shown in the scheme of FIG. 19.

Characterization.

Protein content measurement: Soy meal particles were milled into fine powder in a mill (Cyclone Sample Mill, UDY Corporation, CO, USA) with a 297 μm screen mesh. The powder was dried at 60° C. in vacuum for 24 h. The dried powder was subjected for protein content measurement using a nitrogen/protein analysis instrument (FP-528, LECO corporation, MI, USA). The nitrogen factor for food-based protein is 5.33 (Salo-väänänen, P. P.; Koivistoinen, P. E. Determination of protein in foods: comparison of net protein and crude protein (N×6.25) values. Food Chem. 1996, 57 (1), 27-31). Two duplications were carried out.

Mechanical properties: The sheets were cut into rectangular samples (110 mm×10 mm×2.6 mm). Mechanical properties of the samples were tested using an Instron tensile tester (Instron 5565, Instron Co., Massachusetts, USA) following ASTM D412-98a with a modification, the crosshead speed was 500 mm/min. Stress/strain curves were recorded to obtain strength at break (δb, MPa), and elongation at break (εb, %). At least four specimens were tested to calculate an average value for each treatment.

Moisture content measurement: Samples (1 g) were cut into small particles with an average diameter of about 0.4 mm, weighed and dried at 60° C. in vacuum for 24 h. After the sample weight became constant, the sample was weighed again to calculate the moisture content in the sample.

Scanning Electron Microscopy (SEM): SEM (JSM-6400, JEOL, Japan) was used to observe the sections of samples. Each sample was frozen using liquid nitrogen, then fractured to produce cross-sections using two tweezers. The cross-sections were coated with gold, and then used for SEM observation.

Dynamic Mechanical Analysis (DMA): DMA was carried out using a dynamic mechanical analyzer (DMA Q800, TA Instruments, Delaware, USA) in single cantilever mode. Samples (11 mm×2.5 mm×17.5 mm) were first equilibrated at −100° C. for 1 min, then scanned from −100 to 150° C. at a heating rate of 3° C./min. A variable-amplitude, sinusoidal tensile stress (frequency=1 Hz) was applied to the samples to produce a sinusoidal strain of 15 μm amplitude. Peak temperature of tan δ (T_{tan δ}) was defined as the T_{g} of the samples. E′_{(25° C.)} represents the storage modulus at 25° C. Two duplications were done.

Density measurement: Weight and volume were measured to calculate the density of samples.

Results and Discussion.

Processing properties: As shown in FIG. 19, soy meal particles were extruded into SM thermoplastic, and then blended with natural rubber by extrusion for preparing SMNR thermoplastic. If natural rubber was mixed with soy meal particles instead of SM thermoplastic, the prepared SMNR thermoplastic was not homogeneous due to the presence of visible soy meal particles in the extrudates. Therefore, preparation of SM thermoplastic is necessary for obtaining homogeneous SMNR thermoplastic.

When the extrusion temperature was higher than 110° C., the water in the soy meal melt would evaporate quickly, and the melt viscosity increased sharply, resulting in high extrusion torque. When the extrusion temperature was lower than 90° C., the melt viscosity of natural rubber became high due to the low temperature and the ZSK-30 extruder was easy to stop because of high extrusion torque. In order to extrude soy meal and natural rubber successfully, the optimal melt temperature was selected as 100° C. After ZDEC and sulfur were mixed into the SMNR thermoplastic at 70° C. by roll milling, the mixture could stand for 10 min without any obvious cross-linking phenomenon. This means that the scorch time at 70° C. for the blends is about 10 min, which is in agreement with our previous studies. In this work, the roll milling time at 70° C. was 7 min, which is enough time to prepare homogeneous blends according to the specification of ASTM D3182-89. After SMNR thermoplastic was compression-molded at 115° C. for 10 min, the prepared soy meal sheet showed black color on its surface, indicating that the soy meal had been degraded under these conditions. Therefore, the compression-molding conditions were selected as 100° C. for 10 min to avoid the degradation of the soy meal. Generally, the above processing conditions are in agreement with our previous work in which soy meal and natural rubber were only processed in a micro-twin DSM extruder (15 cm³ in volume capacity, DSM Research, Netherlands). Therefore, both the optimal extrusion temperature and the optimal molding temperature are 100° C.

The processing properties of soy meal made it desirable that the sulfur-accelerator system vulcanize the pre-vulcanized blends at a temperature below 115° C. as quickly as possible. ZDEC was selected as an optimal accelerator in our previous work for this purpose.

In the rubber industry, rubber extruders can provide much higher torque than the ZSK-30 extruder that is usually used for processing general thermoplastics. If the rubber extruders can be used for this work, the soy meal, natural rubber, and vulcanization compounds including ZDEC and sulfur may be extruded together at low temperature (for example, 70-80° C.) to avoid possible cross-linking accidents in the extruder. The prevulcanized SMNR blends will be processed within one step and the step for roll milling will be unnecessary. However, the sulfur-ZDEC system will cause the blends to cross-link in the ZSK-30 extruder if the extruder temperature is 100° C. or over.

Composition: The composition of the raw soy meal, purified soy meal and residues are shown in Table 19. Raw soy meal particles were separated into the purified soy meal and residues. Visual inspection showed that the residues contained a large amount of cellulose fibers and hulls. These fibers will not be melted during extrusion and formed defects in the SMNR blends, resulting in dramatically decreasing the strength of the blends. Therefore, it is necessary to purify the raw soy meal. As shown in Table 19, the protein content of the dried raw soy meal was 46.3%. The protein content of the raw soy meal as received would be 42.8% if the moisture content (7.5%) was considered. The protein content of the residues (35%) was lower than that of raw soy meal (46.3%) due to the presence of the cellulose fiber. This data also indicates that the hulls are associated with proteins in the residues. The protein content of the purified soy meal (48.1%) was higher than that of raw soy meal because the cellulose-based materials were removed.

Compositions of vulcanized SMNR blends, SM and NR on a dry weight basis are shown in Table 20. In our previous work, N-isopropyl-N′-phenylparaphenylenediamine (IPPD) was used as an antioxidant for the vulcanization. However, when the vulcanized SMNR blends containing IPPD were immersed into water for 2 day, the water color became yellow. The yellow discoloration was caused by the presence of IPPD. The mechanical properties of the vulcanized SMNR blend without IPPD were similar to that of the blend containing IPPD. Therefore, the IPPD was not incorporated into the blend systems in these example.

Mechanical properties: The mechanical properties of SMNR blends, SMT and NR at ambient conditions and wet conditions are summarized in Table 21. The strength at break for all blends ranged from 1.8 to 3.9 MPa and elongation at break from 260 to 450%. These results suggest the blends containing about 50 wt % of soy meal are elastic.

When SM content was 48.7% (SN48.7), the strength and elongation were 2.65 MPa and 430.3%, respectively. When SM content was increased to 54.5% (SN54.5), both strength and elongation were decreased to 2.33 MPa and 371.3%, respectively. These results indicate an increase of SM content will reduce the mechanical properties.

Comparing the sample SN54.5 and SN54.5-oven, the samples were identical except for one processing step. The difference of processing between SN54.5 and SN54.5-oven was that the former was vulcanized by compression molding, and the later was vulcanized in an oven. Therefore, SN54.5-oven showed a relative loose structure due to no molding pressure and SN54.5 showed a dense structure due to the molding pressure. The cross-linking density of the rubber in the SN54.5 may also be higher than that in the SN54.5-oven because compression molding had more curing efficiency than heating in an oven. Hence, the mechanical properties (strength of 2.33 MPa, elongation of 371.3%) of SN54.5 were better than that of SN54.5-oven (1.81 MPa, 345.0%) as shown in Table 21. The SN54.5-oven sheet was uniform and showed good surface. The sheet was continuously prepared by roll milling and had an advantage in processing procedure, compared with the compression-molded sheet (SN54.5).

TABLE 19
Composition of the raw soy meal, purified
soy meal and residues

| Dried samples | Yield (%) | Protein content (%) |
|---|---|---|
| Raw soy meal | 100 | 46.3 ± 0.8 |
| Purified soy meal | 87.2 | 48.1 ± 0.2 |
| Residues | 12.8 | 35.0 ± 0.3 |

TABLE 20
Composition of vulcanized SMNR blends, SMT
and NR on a dry weight base (unit: wt %)

| Samples | SM | NR | ZnO | SA | S | ZDEC | CSD | Total |
|---|---|---|---|---|---|---|---|---|
| Example 4-SMT | 100.0 | 0.0 | 0.0 | 0.0 | 0.0 | 0.0 | 0.0 | 100.0 |
| Example 5-SN48.7 | 48.7 | 46.7 | 2.1 | 0.9 | 0.90 | 0.70 | 0.0 | 100.0 |
| Example 6-SN54.5 | 54.5 | 40.5 | 2.4 | 0.9 | 0.90 | 0.8 | 0.0 | 100.0 |
| Example 7-SN54.5-oven | 54.5 | 40.5 | 2.4 | 0.9 | 0.90 | 0.8 | 0.0 | 100.0 |
| Example 8-SN47.2-CSD | 47.2 | 45.6 | 2.1 | 1.0 | 0.90 | 0.7 | 2.5 | 100.0 |
| Example 9-NR | 0.0 | 100 | 0.0 | 0.0 | 0.0 | 0.0 | 0.0 | 100.0 |

TABLE 21
Mechanical properties of SMNR blends, SMT and NR at ambient
condition and wet condition, respectively

| | Ambient condition | | | Wet condition | | |
|---|---|---|---|---|---|---|
| Samples | σ_{b}(MPa) | ε_{b}(%) | Moisture % | σ_{b}(MPa) | ε_{b}(%) | Water uptake % |
| Example 4-SMT | 4.25 ± 0.20 | 8.5 ± 0.6 | 19.0 ± 0.3 | — | — | — |
| Example 5-SN48.7 | 2.65 ± 0.09 | 430.3 ± 20.5 | 2.7 ± 0.1 | 2.10 ± 0.10 | 415.0 ± 54.0 | 20.4 ± 0.8 |
| Example 6-SN54.5 | 2.33 ± 0.03 | 371.3 ± 8.3 | 3.6 ± 0.0 | 1.54 ± 0.13 | 273.0 ± 20.1 | 33.5 ± 1.1 |
| Example 7-SN54.5-oven | 1.81 ± 0.12 | 345.0 ± 6.4 | 3.8 ± 0.0 | 1.04 ± 0.08 | 288.3 ± 15.3 | 40.2 ± 1.3 |
| Example 8-SN47.2-CSD | 3.29 ± 0.06 | 356.0 ± 7.2 | 2.9 ± 0.0 | 3.10 ± 0.20 | 472.0 ± 24.0 | 16.5 ± 0.0 |
| Example 9-NR | 0.2 ± 0.1 | 575 ± 30.1 | 1.0 ± 0.0 | — | — | — |
| Treated SN47.2-CSD | 3.5 ± 0.1 | 331 ± 8.0 | 2.7 ± 0.1 | — | — | — |

TABLE 22
DMA results for the SMNR blends, SMT and NR

| Samples | T_{tan δ} (° C.) | E′ _{(25° C.)}(MPa) |
|---|---|---|
| Example 4-SMT | −25.0 ˜ 90.0 | 204.4 ± 50 |
| Example 5-SN48.7 | −43.7 ± 0.5 | 11.9 ± 1.3 |
| Example 6-SN54.5 | −43.4 ± 0.0 | 45.2 ± 4.2 |
| Example 7-SN54.5-oven | −44.5 ± 0.2 | 16.4 ± 2.1 |
| Example 8-SN47.2-CSD | −42.1 ± 0.0 | 33.3 ± 0.0 |
| Example 9-NR | −48.2 ± 0.0 | 3.0 ± 0.7 |
| Extended SN54.5^{a} | −46.4 ± 0.5 | 6.3 ± 0.5 |
| Extended SN47.2-CSD^{b} | −45.5 ± 0.4 | 6.8 ± 1.1 |

^{a b}Extended SN54.5 and extended SN47.2-CSD were the samples residues after sheets was extended and broken during tensile test.

On the basis of the composition of SN48.7, 2.5% of CSD was added to prepare SN47.2-CSD. Therefore, SN48.7 and SN47.2-CSD had the same composition except for the CSD content. As shown in Table 21, the strength of SN47.2-CSD (3.29 MPa) was much higher than that of SN48.7 (2.65 MPa) but the elongation of SN47.2-CSD (356%) was lower than that of SN48.7 (430.3%). These results suggest CSD is a physical crosslinker, which improved the strength and decreased the elongation of the blends. Calcium sulfate dihydrate (CSD) can interact with protein macromolecules and has been used as a physical cross-linker in many applications (Park, S. K.; Rhee, C. O.; Bae, D. H.; Hettiarachchy, N. S. Mechanical properties and water-vapor permeability of soy-protein films affected by calcium salts and glucono-delta-lactone. J. Agri, Food Chem. 2001, 49 (5): 2308-2312). Soy meal contains about 40% protein and natural rubber is terminated with 3 wt % of protein moieties (Barlow, F. W. In Rubber compounding principles, material and technology; Marcel Dekker Inc.: New York, 1993; p 15). CSD can interact with the protein in the soy meal as well as with the protein in the natural rubber. This means that CSD can act as a physical cross linker as well as a compatibilizer between soy meal and natural rubber.

The moisture content in all vulcanized SMNR blends ranged from 2 to 4 wt % as shown in Table 21. During processing SN47.4, the water content of the extruded soy meal pellets was 22.5±0.0% (not shown in Table 21), and decreased to 8.7±0.1 wt % for the extruded SMNR thermoplastic due to the presence of natural rubber component and the evaporation of water during extrusion. It further decreased to 3.5±0.1 wt % for the prevulcanized SMNR due to the evaporation of water during roll milling, and finally reduced to 2.9±0.1 wt % for vulcanized blends because of the moisture loss during compression-molding. Water as a plasticizer is important to decrease the melt viscosity of the soy meal. Enough water content is a critical condition for smooth extrusion and to prepare homogeneous SMNR blends.

In order to study the water resistance of all samples, the samples were immersed in water for 2 days. The tensile test data of the water-treated samples is summarized in Table 21.

The neat soy meal sheet disintegrated after immersion in water for 2 days, indicating poor water resistance of the neat soy meal material. After the soy meal sheet was exposed at ambient conditions for 2 days, the sheet became brittle due to the loss of moisture. After immersion into water, the strength of all wet blends (SN48.7, SN54.5, SN54.5-oven and SN47.2-CSD) ranged from 1 to 3 MPa, elongation from 288 to 472%, and water uptake from 16 to 40 wt %. Compared to the blends without the water treatment, mechanical properties of the blends changed due to the hydrophilic properties of the soy meal component. The water resistance of the blends improved obviously compared with that of the neat soy meal sample, suggesting the hydrophobic natural rubber efficiently improved the water resistance of the blends.

The treated SN47.2-CSD showed higher strength (3.50 MPa) than SN47.2-CSD (3.29 MPa). During the treatment in which the wet sheets dried at 45° C. for 12 h, the treated SN47.2-CSD experienced post-curing, leading to an increase of strength for the treated sheet.

Density: The density of SN47.2-CSD was 1.15 g/cm³, slightly higher than that of the SN48.7 (1.13 g/cm³), indicating a slight increase of density of the SMNR blends after incorporation of CSD (2.5 wt %).

Morphology.

SEM images of SN48.7 and SN47.2-CSD are shown in FIG. 17. As shown in FIG. 17A, 17B, 17C and 17D, both the samples showed that SM and NR comprised a co-continuous structure where NR formed a network to support the continuous SM matrix. The interphase between natural rubber fibrils and soy meal matrix is continuous and NR was well embedded into the SM matrix, suggesting good adhesion between the NR and SM. Natural rubber contains about 3 wt % of proteins that are enzymes for biosynthesizing natural rubber. The proteins as enzymes are associated with cis-1,4-polyisoprenes by covalent bonds (Cornish, K. Similarities and differences in rubber biochemistry among plant species Phytochemistry 2001, 57, 1123-1134. Tanaka, Y.; Kawahara, S.; Tangpakdee, J. Kautsch Gummi Kunstst Structural characterization of natural rubber Kautschuk Gummi Kunststoffe 1997, 50, 6-11). Therefore, commercial natural rubber is compatible with soy protein through the 3 wt % of protein in natural rubber. The interaction between the protein in the soy meal and the protein in the natural rubber may be hydrogen bonding because hydrogen bonding is the main interaction between proteins and proteins (Wu, Q. X.; Zhang, L. N. Effects of the molecular weight on the properties of thermoplastics prepared from soy protein isolate. J. Appl. Polym. Sci. 2001, 82 (13): 3373-3380). However, the extended SN47.2-CSD and extended SN54.5 showed an obvious heterogeneous morphology (FIGS. 17E and 17F). There were many cavities, indicating some rubber fibers had been pulled out of the soy meal matrix. The rubber components in the extended SN47.2-CSD separated from the soy meal matrix. These results indicate that the interaction between rubber fiber and soy meal matrix was not enough strong to resist tensile stress and was finally destroyed during the tensile test. The rubber component was almost separated from the soy meal matrix in the extended blends and many cavities between the rubber and the soy meal were formed. This change in morphology of the extended blends resulted in whitening of the samples.

In summary, the SEM results indicate that the interaction between NR and SM resulted in a compatible morphology as shown in FIGS. 17A, 17B, 17C and 17D, but the interaction was not enough strong to resist the tensile stress during tensile testing, leading to a heterogeneous structure for the extended sample as shown in FIGS. 17E and 17F. Therefore, the natural rubber and soy meal are only partially compatible.

Thermal Properties.

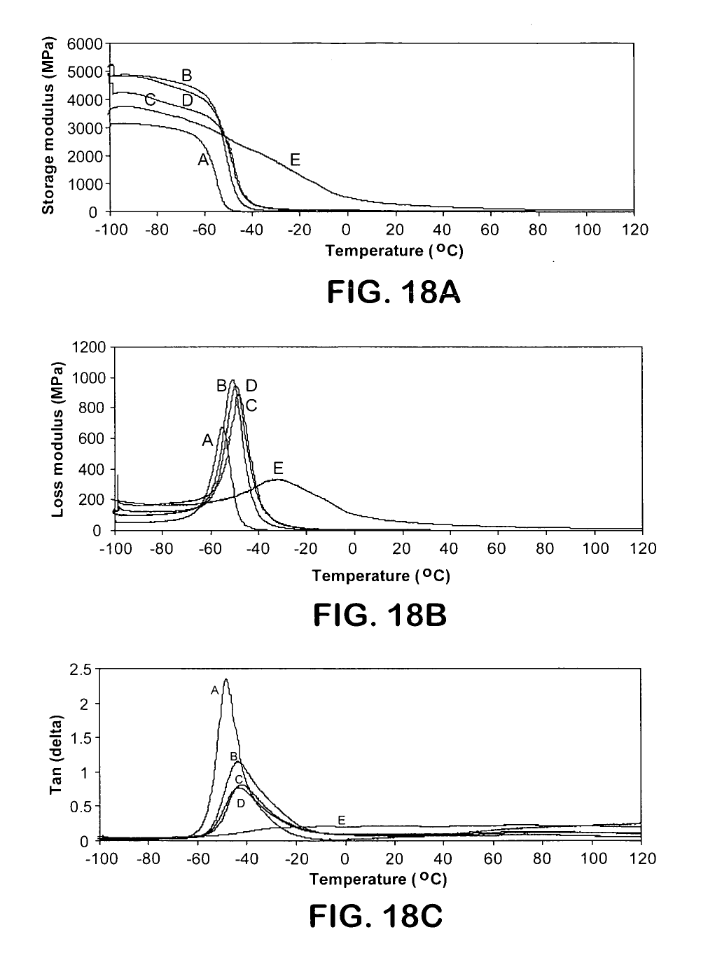

Usually, DMA is more sensitive analysis method to glass transition analysis than differential scanning calorimetry (DSC) (Steven, M. P. Polymer chemistry: an introduction (3rd ed); Oxford University Press: New York, 1999, pp 152). Therefore, DMA was used to analyze the glass transition of the blends. DMA diagrams of NR (line A), SN48.7 (line B), SN47.2-CSD (line C), SN54.2 (line D) and SMT (line E) thermoplastic are shown in FIGS. 18A-C and the results are summarized in Table 22.

As shown in FIG. 18A, the storage modulus at a given temperature for soy meal was higher than that for natural rubber, indicating soy meal was a reinforcing component for natural rubber. Therefore, the E′(25° C.) values for soy meal-natural rubber blends (SN48.7, SN54.5 and SN47.2-CSD) were higher than that for NR (Table 22).

The loss modulus peak temperature of SN47.2-CSD (FIG. 18B, line C) was higher that of the sample without CSD (SN48.7, FIG. 18B, line B), suggesting CSD restricted the macromolecular mobility of the rubber component in the blend. This result indicates that CSD plays a physical or chemical cross-linker role in the blend. The loss modulus peak temperature of SN48.7 was higher than that of natural rubber (FIG. 18B, line A) due to the presence of sulfur cross-linkages and possible interaction between the rubber and soy meal components.

As shown in FIG. 18C, NR showed an intensive tangent delta peak at −48.2° C., which is assigned to the damping absorption for the natural polymer. Soy meal thermoplastic containing 19.1% water showed a broad and weak glass transition from −25° C. to about 90° C. Soy meal contains protein, cellulose, etc. (Endres, J. G. Soy protein products characteristics, nutritional aspects, and utilization; AOCS Press: Illinois, 2001, pp 4-8). The complex and heterogeneous composition led to the broad and weak glass transition of soy meal. This glass transition of soy meal is sensitive to the moisture content in the soy meal because water is a plasticizer for protein or cellulose. The natural rubber content in the SMNR blends is less than 50 wt %, resulting in the weak tangent delta peak intensity for the blends in contrast to the sharp tangent delta peak for the natural rubber.

As shown in Table 22, the “extended SN54.5” represents the SN54.5 residues that had been extended and broken during tensile test. The composition and processing history of the extended SN54.5 and SN54.5 were the same as each other except for the above treatment. As shown in SEM image analysis (FIG. 17F) the natural rubber component and soy meal component in the extended SN54.5 were separated, indicating that the interaction between the NR and SM was almost destroyed by tensile stress. Therefore, the structure difference between the SN54.5 and the extended SN54.5 is that the interaction between the NR and the SM in the SN54.5 is higher than that in the extended SN54.5. This structure difference led to the rubber macromolecular mobility in the SN54.5 being lower than that in the extended SN54.5 and finally resulted in the T_{tan δ} of SN54.5 (−43.4° C.) being higher than that of the extended SN54.5 (−46.4° C.). The T_{tan δ} difference between SN54.5 and the extended SN54.5 was 3.0° C., which was an important parameter to evaluate the interaction degree between the rubber component and the soy meal component in their blends. Namely, the T_{tan δ} of the rubber in the SN54.5 was increased by 3.0° C., compared with that in the extended SN54.5, due to the presence of the interaction between the rubber component and the soy meal matrix.

The rubber component and the soy meal matrix formed a rigid network in SN54.5 due to the presence of the interaction between the rubber component and the soy meal. But the network for the extended SN54.4 was destroyed during tensile testing as proved by SEM analysis. The E′_{(25° C.)} of the SN54.5 (45.2 MPa) increased by 38.9 MPa compared with that in the extended SN54.5 (6.3 MPa). The T_{tan δ} of the extended SN54.5 (−46.4° C.) was higher by about 1.8° C. than that of NR (−48.2° C.), which is caused by sulfur cross-linkages in the rubber component of the extended SN54.5.

As shown in Table 22, the T_{tan δ} of the rubber in the SN47.2-CSD (−42.1° C.) was increased by 3.4° C. compared with that in the extended SN47.2-CSD (−45.5° C.). This result further proved the presence of interaction between the rubber component and the soy meal matrix.

The T_{tan δ} of the rubber in SN47.2-CSD was higher by about 1.6° C. than that of SN48.7 (−43.7±0.5° C.), further suggesting CSD restricted the molecular mobility of natural rubber and CSD played a cross-linker role. Because CSD is a highly stiff material and the cross-linking density of natural rubber in SN47.2-CSD was higher than SN48.7, the E′_{(25° C.)} of SN47.2-CSD (33.3 MPa) was higher than that of SN48.7 (11.9 MPa).

The effects of calcium salts on the mechanical properties of soy protein isolate film were studied by Park et al. who reported that calcium sulfate acted as a cross linker to form a protein film with a rigid three dimensional structure (Park, S. K.; Rhee, C. O.; Bae, D. H.; Hettiarachchy, N. S. Mechanical properties and water-vapor permeability of soy-protein films affected by calcium salts and glucono-delta-lactone. J. Agri, Food Chem. 2001, 49 (5): 2308-2312). Yuan et al reported the divalent calcium cations from calcium salts bind to the negative charges of the protein side groups, and adjust the isoelectric point of the proteins to cause the aggregation of proteins (Yuan, Y. J.; Velev, O. D.; Chen, K.; Campbell, B. E.; Kaler, E. W.; Lenhoff, A. M. Effect of pH and Ca2+-induced associations of soybean proteins. J. Agric. Food Chem. 2002, 50 (17): 4953-4958). The conclusions in the above two references support the hypothesis that the CSD was a physical cross-linker in the blends in our work.

The difference between SN54.5 and SN54.5-oven is that SN54.5 was vulcanized by compression molding and the SN-54.5-oven by directly heating in an oven. The difference in the vulcanization method leads to the difference of the two T_{tan δ} values as shown in Table 22. Furthermore, the T_{tan δ} of SN54.5 (−43.4° C.) was lower than that of SN54.5-oven (−44.5° C.), implying that the macromolecular mobility of rubber in the former sample was lower than that in the latter. This result indicates the cross-linking density of rubber in SN54.5 is higher than that in SN54.5-oven. It suggests that compression-molding at 100° C. for 10 min is more efficient than heating in an oven at 90° C. for 20 min for vulcanizing the soy meal and natural rubber blends. The E′_{(25° C.)} of SN54.5 (45.2 MPa) is much higher than that of SN54.5-oven (16.4 MPa), indicating SN54.5 is more stiff than SN54.5-oven at room temperature. This is because the molded SN54.5 has a denser structure and higher cross-linking density for natural rubber. A lower cross-linking density for natural rubber in SN54.5-oven is another reason why SN54.5-oven showed less strength and less elongation than that of SN54.5, as shown in Table 21.

Conclusions: Vulcanized soy meal and natural rubber blends containing about 50 wt % of soy meal were successfully processed at a pilot scale by extrusion, roll milling and compression-molding. Both the optimal extrusion temperature and compression-molding temperature are 100° C. The optimal roll milling temperature is 70° C. The strength at break for all blends ranged from 1.8 to 3.9 MPa and elongation at break from 260 to 450%. These results suggest the blends containing about 50 wt % of soy meal are elastic.

Hydrophobic natural rubber efficiently improved the water resistance of the blends. Morphology showed that the natural rubber component was well embedded into the soy meal matrix, indicating the presence of an interaction between the rubber and the soy meal. The rubber component separated from the soy meal matrix after the blends were extended during tensile testing, suggesting the interaction was not strong. DMA and SEM analysis showed that the glass transition temperature of the rubber component in the blends increased due to the presence of the interaction between the rubber and the soy meal in the blends. DMA analysis also showed that CSD restricted the molecular mobility of natural rubber and CSD played a physical cross-linker role. The interaction between the soy meal and the protein moieties terminated with the natural rubber may be hydrogen bonding. CSD is a physical crosslinker of the proteins in the soy meal and in the rubber, and thus improves the mechanical properties of the blends.

The blends containing near 50 wt % of soy meal were elastic, cold resistant and low cost, indicating a potential in applications. This work proved that it is possible to process the soy meal and natural rubber blends at a pilot scale.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the Claims attached herein.

We claim:

1. An uncured and unvulcanized thermoplastic blended composition which comprises:
(a) a soy meal mixture, the soy meal which has been treated to remove hulls and cellulose fiber materials associated with soy beans, the mixture comprising about 20% or less by weight water; and
(b) an unvulcanized natural rubber mixture having sulfur as a vulcanization agent and a vulcanization accelerator, wherein the blended composition can be vulcanized to a thermoset solid.

2. The composition of claim 1 wherein the soy meal mixture has been processed at 80-100° C.

3. The composition of claim 1 wherein the soy meal mixture to natural rubber mixture ratio is approximately 70:50 (w/w).

4. The composition of claim 1 wherein the vulcanization accelerator is a dithiocarbamate accelerator.

5. The composition of claim 4 wherein the dithiocarbamate accelerator is zinc diethyldithiocarbamate (ZDEC).

6. The composition of claim 1 further comprising a compatibilizer.

7. The composition of claim 6 wherein the compatibilizer is calcium sulfate dihydrate (CSD).

8. A thermoset blended composition which comprises:
(a) a soy meal mixture, the soy meal which has been treated to remove hulls and cellulose fiber materials associated with soy beans, the mixture comprising about 20% or less by weight water; and
(b) a natural rubber mixture having sulfur as a vulcanization agent and a vulcanization accelerator, wherein the blended composition has been vulcanized to a thermoset solid.

9. The composition of claim 8 wherein the soy meal mixture to natural rubber mixture ratio is approximately 70:50 (w/w).

10. The composition of claim 8 wherein the soy meal is approximately 51 percent by weight of the composition when dried.

11. The composition of claim 8 wherein the vulcanization accelerator is a dithiocarbamate accelerator.

12. The composition of claim 8 wherein the dithiocarbamate accelerator is zinc diethyldithiocarbamate (ZDEC).

13. The composition of claim 8 which has been vulcanized at approximately 90° C.

14. The composition of claim 8 wherein the soy meal mixture has been processed at 80-100° C.

15. The composition of claim 8 further comprising a compatibilizer.

16. The composition of claim 15 wherein the compatibilizer is calcium sulfate dihydrate (CSD).

17. A method for the production of a thermoset blended composition which comprises:
(a) providing a soy meal mixture, which has been treated to remove hulls and cellulose fiber materials associated with soy beans, the soy meal mixture comprising about 20% or less by weight water; and unvulcanized natural rubber containing sulfur as a vulcanization agent, and a vulcanization accelerator; and
(b) vulcanizing the blended composition to produce the thermoset solid composition.

18. The method of claim 17 wherein the vulcanization is performed between 25° C. and 140° C., preferably between 50° C. and 95° C.

19. The method of claim 17 wherein the soy meal mixture has been processed at 80-100° C.

20. The method of claim 17 wherein the soy meal mixture to natural rubber mixture ratio is approximately 70:50 (w/w).

21. The method of claim 17 wherein the vulcanization accelerator is a dithiocarbamate accelerator.

22. The method of claim 21 wherein the dithiocarbamate accelerator is ZDEC.

23. The method of claim 17 wherein the soy meal is approximately 51 percent by weight of the thermoset composition when dried.

24. The method of claim 17 wherein the soy meal mixture and unvulcanized natural rubber provided in step (a) further comprises a compatibilizer.

25. The method of claim 24 wherein the compatibilizer is calcium sulfate dihydrate (CSD).

26. A thermoset blended composition which comprises:
(a) soy meal, which has been treated to remove hulls and cellulose fiber materials associated with soy beans, the soy meal containing less than about 7.5% to 17.5% water; and
(b) vulcanized natural rubber.

27. The composition of claim 26 wherein the composition comprises 30% to 70% soy meal, 12.5% to 62.5% rubber which has been vulcanized, and 7.5% to 17.5% water, all by weight.

28. The composition of claims 26 or 27 wherein the rubber was vulcanized with sulfur as a vulcanization agent and a vulcanization accelerator.

29. The composition of claims 26 or 27 wherein the rubber was vulcanized with sulfur and zinc diethyldithiocarbamate as a vulcanization accelerator.

30. The composition of claim 26 which is substantially free of organic plasticizers.

31. The composition of claim 26 further comprising a compatibilizer.

32. The composition of claim 31 wherein the compatibilizer is calcium sulfate dihydrate (CSD).

33. An uncured and unvulcanized thermoplastic blended composition which comprises:
(a) a blend of soy meal, which has been treated to remove hulls and cellulose fiber materials associated with soy beans, the soy meal comprising between about 5% and 10% by weight water; and
(b) unvulcanized natural rubber containing sulfur as a vulcanization agent and a vulcanization accelerator, wherein the blended composition can be vulcanized to a thermoset solid.

34. The composition of claim 33 wherein the composition comprises 30% to 70% soy meal, 12.5% to 62.5% vulcanized natural rubber, and 8% to 10% by weight water, all by weight.

35. The composition of claims 33 or 34 wherein the unvulcanized natural rubber comprises sulfur as a vulcanization agent and zinc diethyldithiocarbamate as an accelerator.

36. The composition of claims 33 or 34 which is substantially free of organic plasticizers.

37. The composition of claim 33 further comprising a compatibilizer.

38. The composition of claim 37 wherein the compatibilizer is calcium sulfate dihydrate (CSD).

39. A method for the production of a thermoset blended composition which comprises:
(a) providing a blend of soy meal, which has been treated to remove hulls and cellulose fiber materials associated with soy beans, the soy meal comprising between about 5% and 10% by weight water; and unvulcanized natural rubber containing sulfur as a vulcanization agent, and a vulcanization accelerator; and
(b) vulcanizing the blended composition to produce the thermoset solid composition.

40. The method of claim 39 wherein the vulcanization is between 25° C. and 140° C., preferably between 50° C. and 95° C.

41. The method of claim 39 wherein the soy meal is in a particle form and is exposed to an air stream to separate the materials from the soy meal.

42. The method of claims 39 or 40 wherein (a) the soy meal and the water; and (b) the natural rubber, the accelerator and the sulfur are blended in an extruder to provide the blend of step (a).

43. The method of claim 39 wherein (i) the soy meal and the water, and (ii) the natural rubber, sulfur and accelerator are blended together in a mixer to provide the blend of step (a).

44. The method of claim 39 wherein the blend of step (a) further comprises a compatibilizer.

45. The method of claim 44 wherein the compatibilizer is calcium sulfate dihydrate (CSD).

46. A method for the preparation of a prepared granular soy meal which comprises:
(a) providing a granular natural soy meal containing dispersed hulls and cellulose fiber materials associated with soy beans; and
(b) blowing a gas through a stream of the granular natural soy meal to remove the materials which are lighter than the granular soy meal to provide the prepared granular soy meal.

47. The method of claim 46 wherein the gas is air under ambient conditions.

48. The composition of claim 26 as a film, band or tube.
